(19) United States
(12) Patent Application Publication
(10) Pub. No.: US 2024/0402406 A1
(43) Pub. Date: Dec. 5, 2024

(54) WIRE GRID POLARIZER REFLECTION CONTROL WITH COLORED FILMS

(71) Applicant: HOYA Optical Labs of America, Inc., Lewisville, TX (US)

(72) Inventors: Jeffrey Brown, Ramsey, MN (US); Theodore Ryan Knutson, Ramsey, MN (US); Michael S. Boulineau, Ramsey, MN (US); Gregory Carlson, Ramsey, MN (US)

(73) Assignee: HOYA Optical Labs of America, Inc., Lewisville, TX (US)

(21) Appl. No.: 18/699,153

(22) PCT Filed: Oct. 18, 2022
(86) PCT No.: PCT/US2022/078312

§ 371 Date: Apr. 5, 2024

Related U.S. Application Data
(60) Provisional application No. 63/262,679, filed on Oct. 18, 2021.

(51) Int. Cl. G02B 5/30; G02B 1/08; G02B 5/08

(52) U.S. Cl. CPC G02B 5/3058; G02B 1/08; G02B 5/0808; G02B 5/305

(57) ABSTRACT

A wire grid polarizer having a mirror layer is laminated with a colored film. The colored film provides a scratch protection of the mirror layer of the wire grid polarizer and provides a colored mirror appearance of an optical lens made with such wire grid polarizer. The colored film laminated wire grid polarizer shows different intensities between the transmitted and reflected colors when the wire grid polarizer is paired with a particular colored film. The wire grid polarizer is deposited on a structured surface of a photochromic film to form a photochromic wire grid polarizer.

### RELATED APPLICATIONS

This application claims benefit of and priority to U.S. Provisional Application Ser. No. 63/262,679 filed Oct. 18, 2021, entitled Wire Grid polarizer Reflection Control With Colored Films, which is hereby incorporated herein by reference in its entirety.

### BACKGROUND OF THE INVENTION

Polarizing functionality for optical lenses is required to be transmissive by virtue of its use as an eye lens and is typically provided by use of a stretched polyester or polyvinyl alcohol or PVA film that is subsequently imbibed with a conductive material such as iodine or suitable organic dye. Such stretched film polarizing sheets can have up to 99.9 percent polarizing efficiency. However, at such high levels of efficiency, the optical transmission is typically reduced to a level close to 20 percent.

Another type of polarizing filter, which can be a potential alternative to the currently available PVA based polarizing filter, is a wire grid polarizer that typically uses fine metal wires lithographically deposited a short distance apart from each other on a substrate. Due to their high thermal stability, wire grid polarizers are typically used in video projection systems, medical imaging, and digital cameras. Wire grid polarizers are much less common for use in eyewear due to its relative expense compared to other common polarizing techniques and these metal grids tend to reflect incident light back into a wearer's eyes, causing visual disturbances. Hence, wire grid polarizers have remained less popular with eyeglass manufactures due to this expense and unfavorable reflective performance characteristics.

However, if the backside reflection and the production cost of the wire grid polarizer can be controlled, then this type of polarizer will be a better option for the sunglasses industries because of the higher thermal stability of the wire grid polarizers than the currently available PVA based or other similar polarizing filters.

Wire grid polarizer containing optical lens can be more aesthetically pleasing and desirable if the polarizers can be coated with an additional layer of a mirror stack to provide a mirror finish or a reflective coating on the wire grid polarizer can be formed by reflective conductor metals.

However, existing technology to apply a mirror finish to a polarized optical lens uses a batch sputtering or vacuum deposition processes. These processes are expensive, mainly because they cannot access the economy of scale found in a continuous process. Moreover, these processes produce a polarized lens which has the mirror layer deposited last to remain it on the lens surface where it can be exposed to other hazards inherent in the use, transportation, and storage of the lenses. Hence, the mirror coating is vulnerable to abrasions and environmental damage that can degrade the polarized optical lens. For example, when damage (e.g., a scratch) occurs in the mirror stack in such a lens, it is relatively noticeable and degrades the visual appearance of the optical lens. There are additional limitations to the traditional vacuum deposition methods, particularly in that the process is challenging to apply a silver mirror, which is a commercially desirable option.

Therefore, it would be advantageous to provide a mirror finished polarized optical lens that incorporates an additional film, for example a colored film, or other similar functional film, for example, a functional photochromic film, on top of the mirror layer, wherein the colored film or the functional photochromic film, may act as a protective layer of the mirror finish of the polarizer from abrasions and other environmental damages.

Hence, there is a need to develop a wire grid polarized optical lens using an improved wire grid polarizer that has reduced reflectance on the back or wearer's side of the lens, can be produced cost effectively in large scale and having a mirror finish on the front or viewer side of the lens, wherein the mirror layer can be protected with an aesthetically appealing, transparent, colored film of choice or a functional photochromic film.

### SUMMARY OF THE INVENTION

The present specification describes a wire grid polarizer for polarizing an incident light beam, comprising an array of parallel composite wires. In some examples, each of the composite wires comprise a coating stack having at least one high refractive index material layer coated on a low refractive index metal layer, wherein the coating stack is configured to reduce a back reflection of the wire grid polarizer below 6%.

In some examples, a silver mirror layer may be deposited on the top surface of the wire grid polarizer and a colored film may be laminated with the mirror layer to protect the mirror layer from abrasions and environmental damages. When this colored film laminated mirror finished wire grid polarizer is incorporated into an optical lens, it may provide an aesthetically appealing colored mirror appearance of the optical lens to a viewer and the wire grid polarizer may reduce a back-side reflection of the optical lens below 6%.

In some examples, the wire grid polarizer may show different intensities of transmitted and reflected colors when the wire grid polarizer is laminated with the colored film. In such case, the intensity of the reflected color of the colored film laminated wire grid polarizer may be higher than the intensity of the transmitted color of the colored film laminated wire grid polarizer.

In some examples, an optical lens may contain a functional photochromic film having a structured surface and a wire grid polarizer may be deposited on the structured surface of the functional photochromic film to form a laminate. The laminate containing the functional photochromic film and the wire grid polarizer may be sandwiched between two additional protective layers. In some examples, the protective layers may contain same material as the base material of the optical lens.

According to some examples, the colored film laminated mirror finished wire grid polarizer may be configured to reduce only the back reflection of the optical lens when the high refractive index metal layer is coated towards the wearer's side of the wire grid polarizer. In some examples, the colored film laminated mirror finished wire grid polarizer is configured to reduce only the front side reflection of the optical lens when the high refractive index metal layer is coated towards the viewer's side of the wire grid polarizer. In some examples, the colored film laminated mirror finished wire grid polarizer is configured to reduce both the front side and back side reflection of the optical lens when the high refractive index layer is coated on both the viewer's and wearer's sides of the wire grid polarizer. According to some examples, the colored film laminated mirror finished wire grid polarizer is configured to reduce the back reflection of the optical lens to about 2%.

### BRIEF DESCRIPTION OF THE DRAWINGS

These and other aspects, features and advantages of which examples of the invention are capable of will be apparent and elucidated from the following description of examples of the present invention, reference being made to the accompanying drawings, in which:

FIG. 1 is an elevation view of an ophthalmic article according to certain examples of the present invention.

FIG. 2 is a sectional view of one example of a wire grid polarizer deposited on a glass substrate of a lens.

FIG. 3 is a reflection spectrum from a control Al layer and a layer of Glass\Al\SiO₂\Zr.

FIG. 4 is a reflection spectrum of a glass slide and SiO₂\ZrSiO₂ reflection control layer (No Al layer present) and a glass slide and Al layer and SiO₂\ZrSiO₂ reflection control layer.

FIG. 5 is a transmission spectrum of a glass slide and SiO₂\Zr\SiO₂ reflection control layer (No Al layer present).

FIG. 6 is a transmission spectrum of a wire grid polarizer with the reflection control layer SiO₂\Zr\SiO₂ on glass slide and Al layer and without the reflection control layer SiO₂\Zr\SiO₂ on glass slide and Al layer.

FIG. 7 is a reflection spectrum of a wire grid polarizer without the reflection control layer SiO₂\Zr\SiO₂ on the front and back sides of the glass slide and Al layer.

FIG. 8 is a reflection spectrum of a wire grid polarizer with the reflection control layer SiO₂\Zr\SiO₂ on the front and back sides of the glass slide and Al layer.

FIG. 9 is a plot showing refractive indices and extinction coefficients for ZrOₓN_{y} coating.

FIG. 10 is a table showing important refractive indices including ZrOₓN_{y}, Zr and Al.

FIG. 11 is reflection spectra of Al (control layer) and ZrOₓN_{y}/Al/ZrOₓN_{y} stacks with the different target thicknesses of ZrOₓN_{y} coatings under different gas flows.

FIG. 12 is an optical admittance diagram for Al/ZrOₓN_{y} coating.

FIG. 13 is a table of required extinction coefficient and thickness to minimize reflection from Al calculated using admittance calculator.

FIG. 14 is plot showing admittance loci for different refractive indices.

FIG. 15 is a table showing refractive indices of different materials at 550 nm.

FIG. 16 is a plot showing refractive indices of Ge under different O₂ flows by E-beam evaporation.

FIG. 17 is a plot showing extinction coefficients of Ge under different O₂ flows by E-beam evaporation.

FIG. 18 is maximum transmission spectra of polarized light for coatings on patterned samples.

FIG. 19 is minimum transmission of polarized light for coatings on patterned samples.

FIG. 20 is reflection spectra from Ge side and Al side of patterned sample. The coating structure is PUA/Al/Ge.

FIG. 21 reflection spectra from front and back of patterned samples with Ge/Al/Ge coating and Al reflection spectra as a reference.

FIG. 22 is transmission plots after modification of Al process with and without Ge.

FIG. 23 is comparative SEM images of (i) initial pattern (no coating); (ii) Al coated sample; (iii) Ge—Al coating.

FIG. 24 is a schematic representation of modification of the wire grid polarizer period to control the spacing between wires or grids.

FIG. 25A is a plot showing reflection of Ge with corresponding Ge thicknesses under 400-800 nm of light.

FIG. 25B is a plot showing reflection of Ge with corresponding Ge thicknesses under 550 nm of light.

FIG. 25C is a plot showing transmission of Ge with corresponding Ge thicknesses under 400-800 nm of light.

FIG. 25D is plot showing transmission of Ge with corresponding Ge thicknesses under 550 nm of light.

FIG. 26A is a plot showing reflection of Al with corresponding Al thicknesses under 400-800 nm of light.

FIG. 26B is a plot showing reflection of Al with corresponding Al thicknesses under 550 nm of light.

FIG. 26C is a plot showing transmission of Al with corresponding Al thicknesses under 400-800 nm of light.

FIG. 26D is plot showing transmission of Al with corresponding Al thicknesses under 550 nm of light.

FIG. 27 is a schematic representation of the structure of a colored film laminated wire grid polarizer with one sided (wearer's side) reflection control laminated between two base films.

FIG. 28 is a schematic representation of the structure of a colored film laminated wire grid polarizer with two-sided reflection control laminated between two base films.

FIG. 29 is a schematic representation of the structure of a colored film laminated wire grid polarizer with one sided (wearer's side) reflection control laminated with one base film.

FIG. 30 is a schematic representation of the structure of a colored film laminated wire grid polarizer with back side (wearer's side) reflection control laminated with one base film.

FIG. 31 is a schematic representation of the structure of a photochromic layer laminated a wire grid polarizer with back side (wearer's side) reflection control laminated between two base films.

FIG. 32 is a schematic representation of the structure of a photochromic layer laminated wire grid polarizer with one sided (wearer's side) reflection control laminated between two base films.

FIG. 33 is a plot showing % of transmission of different colored film laminated wire grid polarizers in comparison to a wire grid polarizer having no laminated colored film.

FIG. 34 is a plot showing % of reflection of different colored film laminated wire grid polarizers in comparison to a wire grid polarizer having no laminated colored film.

FIG. 35 shows data for L*, a*, and b* values for both transmission (T) and reflection (R) of different colored films on the wire grid polarizers and a wire grid polarizer having no laminated colored film.

### DESCRIPTION OF EMBODIMENTS

Specific examples of the invention will now be described with reference to the accompanying drawings. This invention may, however, be embodied in many different forms and should not be construed as limited to the examples set forth herein; rather, these examples are provided so that this disclosure will be thorough and complete, and will fully convey the scope of the invention to those skilled in the art. The terminology used in the detailed description of the examples illustrated in the accompanying drawings is not intended to be limiting of the invention. In the drawings, like numbers refer to like elements. While different examples are described, features of each example can be used interchangeably with other described examples. In other words, any of the features of each of the examples can be mixed and matched with each other, and examples should not necessarily be rigidly interpreted to only include the features shown or described.

One aspect of the present specification is aimed at creating wire grid polarizers in wafers using roll to roll technology (Nano-imprint lithography or NIL) for cost effectiveness and scaling up the production of the wire grid polarizers such that they can be applied to optical lenses to form wire grid polarized optical lenses in large quantities.

Another aspect of the present invention seeks to generate a mirror coated wire grid polarizer with reduced backside reflection to the wearer's eyes and a colored mirror like appearance of the front side to an observer with either a colored film or a functional film, for example, a photochromic film, laminated to the mirror coated layer. This can be achieved by designing a substrate, for example, a polymer grid on a glass slide and coating the polymer grid with a high reflectivity metal layer, for example, an aluminum (Al) layer and depositing another metal component having high absorbance, for example, a Zirconium (Zr) or Nickel (Ni) of Germanium (Ge) on top of the aluminum layer by, for example, vacuum deposition method. The wire grid polarizer may further be provided with a mirror finish by coating with, for example, a silver mirror layer through the vapor deposition method or a reflective coating by reflective conductor metals, for example, gold, aluminum, copper, niobium, chromium, tin, or similar metals. Finally, the mirror finished polarizer layer may be laminated with a transparent colored film of choice or a functional photochromic film to form a colored mirror finished wire grid polarizer. In some other examples, the mirror finished wire grid polarizer layer may be laminated with a transparent colored film and any other layers, for example but not limited to, anti-reflective layer, antifogging layer, easy clean layer or other similar layers.

In this application, the frontside of the optical article refers to the viewer's side and the backside of the optical article refers to the wearer's side. The frontside and viewer's side, as well as the backside and wearer's side are used interchangeably throughout the application.

In some examples, the thickness of the transparent colored film may be in a range of about 0.1 mm 0.4 mm, when the transparent colored film is, for example, a polycarbonate film. In some other examples, if the color or tint may be present in the functional photochromic layer, then the thickness of the functional photochromic film in the laminate may be in a range of about 10-50 microns.

In this specification, some non-limiting examples of the metal components having high absorbance may include zirconium (Zr), nickel (Ni) or germanium (Ge) and some non-limiting examples of the polymer grid may include polycarbonate, polyurethane acrylate or polyurethane. The colors of the colored film are limited only by the availability of different film colors and some common non-limiting examples of the film colors may include blue, red, green, deep straw and lavender. In some non-limiting examples, the transparent component of the colored films may be made of compounds comprising, for example, polycarbonate or tri-acetyl cellulose.

In some examples, colorings can be added to the transparent films in different ways. In some common non-limiting examples, the transparent films may be usually mixed in a master batch and then extruded or sheet casted to make the colored films. In some non-limiting examples, processes similar to tinting may be used to diffuse the color into the transparent film. In some examples, commercially available colored transparent films may be used in the present application.

According to some examples, the wire grid polarizer layer of the present application may be laminated with a functional photochromic layer to form a photochromic wire grid polarizer.

In certain examples of the present specification, the surface upon which the wire grid polarizer with a colored transparent film or with a photochromic layer is laminated is a front or back surface of an unfinished, single or multifocal optical lens puck or a front or back surface of a finished, single or multifocal optical lens. In certain examples of the present specification, the desired front or back surface structure is formed on the optical article during the casting or injection molding process.

Broadly speaking, the first objective of the present invention is to achieve the formation of wire grid polarizer that polarizes electromagnetic radiation in a range of wavelengths that is within the visible spectrum, e.g., approximately 380 to 780 nanometers. The second objective of the present invention is to laminate the wire grid polarizer with a colored transparent film or with a photochromic layer to form a colored wire grid polarizer or a photochromic wire grid polarizer.

The first objective is achieved by first forming a structured surface on an ophthalmic or optical article, such as a lens, a film, or a film laminate. The structured surface may employ a system of linear patterns or features ranging in the scale of nanometers to hundreds of nanometers. U.S. Pat. No. 10,838,128 B2, the content of which is incorporated in its entirety by reference, also discloses the formation of wire grid polarizers that polarize electromagnetic radiation in visible range on an ophthalmic or optical article, such as a lens, a film, or a film laminate.

In certain examples of the present specification, the surface upon which the inventive wire grid polarizer is formed is a front or back surface of an unfinished, single or multifocal optical lens puck or a front or back surface of a finished, single or multifocal optical lens.

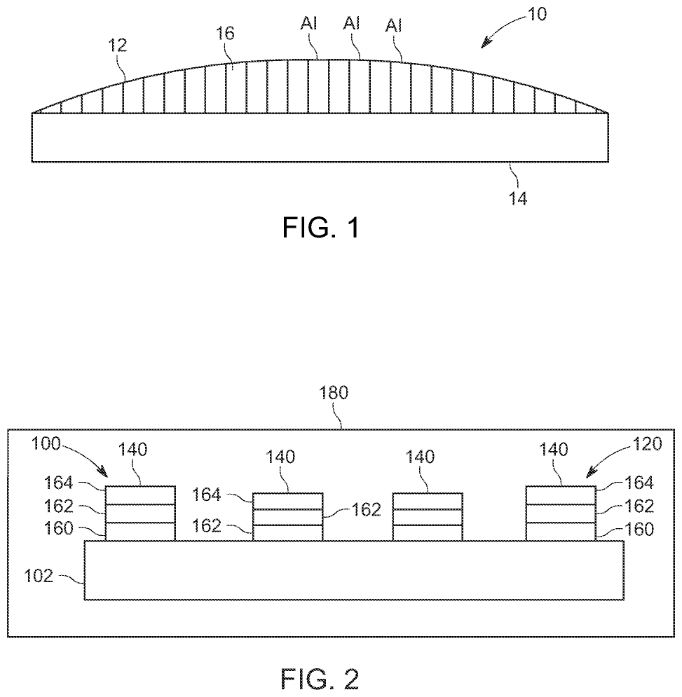

FIG. 1 is an elevation view of a finished or semi-finished lens 10, according to certain examples of the present specification, having a front side 12 and a back side 14. The lens 10 employs a surface structure 16 on the front surface 12 that was formed either during the lens molding process or as a result of direct surfacing of the front side 12. In some examples of the present specification, the surface structure 16 comprises coating the front surface 12 with high reflectivity grids, for example, aluminum (Al) grids.

In some examples, the present specification demonstrates a wire grid polarizer with Al grids for use in an optical lens which may reduce the back reflection. To achieve this back reflection control, an additional absorbing metal layer, for example but not limited to Zr or Ni layer, deposited on the Al wires covered with a dielectric layer which includes but not limited to a SiO₂ gap or spacer layer. The presence of additional absorbing metal layers on Al grids is effective in reducing reflectance of the wire grid polarizers made of high reflectivity Al grids.

FIG. 2 illustrates one example of a lens stack 100 comprising a base lens blank 102 (also referred to as a substrate) and a wire grid polarizer 120 disposed on a front surface of the lens blank 102. The lens blank 102 can be polycarbonate, glass, or other materials suitable for use as an ophthalmic lens.

The wire grid polarizer 120 generally includes a plurality of fine metal wires or composite metal lines 140 that have been deposited by E-Beam evaporation, standard thermal evaporation, sputtering or lithographically on the lens blank or substrate 102 in a parallel orientation relative to each other. These metal wires can be spaced apart from each other between 40 and 150 nm. In a specifical example, the metal wires are spaced apart about 60 nm.

Each of the wires or composite metal lines 140 of the wire grid polarizer 120 comprise a first metal layer 160 deposited directly on the surface of the lens or substrate 102, a dielectric layer 162 deposited on the first metal layer 160, and a second metal layer 164 deposited on the dielectric layer 162.

In some examples, the wire grid polarizer 120 with the lens blank 102 is embedded in a laminate 180. In some examples, non-limiting examples of the laminate comprises a polyurethane adhesive contained between two sheets of polycarbonate.

In some examples, the first metal layer 160 includes but is not limited to Al. The thickness of each aluminum layer may have a range between 10-30 nm. Al layer comprises a low refractive index of about 0.789 to 1.015 at 550 nm depending on the deposition process or the quality of the Al. Therefore, Al is a high reflectivity metal even at low thickness. The Al grids in the wire grid polarizer can be spaced apart from each other between 40 and 150. In a specific example, the metal wires are spaced apart about 60 nm.

The dielectric layer 162 includes but is not limited to SiO₂. The thickness of the SiO₂ layer may vary in a range between 1-120 nm. By varying the thickness of the SiO₂ layer, the reflection can be minimized. In this regard, high refractive index means an index of refraction that is approximately greater than about 1.7 at a referenced wavelength, for example a wavelength of about 550 nanometers. Low refractive index means an index of refraction that is approximately less than about 1.5 at a referenced wavelength, for example a wavelength of about 550 nanometers. For this example, the refractive index of the SiO₂ layer is 1.5.

The second metal layer 164 includes but is not limited to Ni or Zr. The thickness of the Ni or Zr layer may vary. In one example, a non-limiting example of the thickness of the Ni or Zr layer is 5 nm. Ni or Zr are high absorbing metals. Zr has a refractive index of 2.5315 and Ni has a refractive index of 1.8 at 550 nm.

In one specific example, the first metal layer is composed of Al having a thickness of 27.5 nm and spaced apart from other wires by 60 nm, the dielectric layer 162 is composed of SiO₂ and has a thickness of 65 to 70 nm, and the high absorbing second metal layer is composed of Zr and has a thickness of 7 nm. In one example, the lens stack is formed by depositing the first metal layer (e.g., Al) via E-beam deposition, thermal evaporation or collimated sputtering.

In some examples, the basic structure for reflection control comprises a basic structure of Glass\Al\SiO₂\Zr layer, where glass is used as a substrate and on top surface of the glass substrate, a grid or array of parallel, elongated, composite wires are disposed (not shown in the figures). The thickness of the coated layer can be fixed or varied in the basic structure of Glass\Al\NSiO₂\Zr. In some examples, the Zr thickness in the basic structure is fixed. In some examples, the thickness of the Zr includes but not limited to 5 nm but the thickness of the SiO₂ is varied. In the structure of Glass\Al\SiO₂\Zr, the Al layer thickness is made optically opaque so that the reflection could be measured from the back side (i.e., Al only) and the front side (i.e., Al and reflection control with Zr).

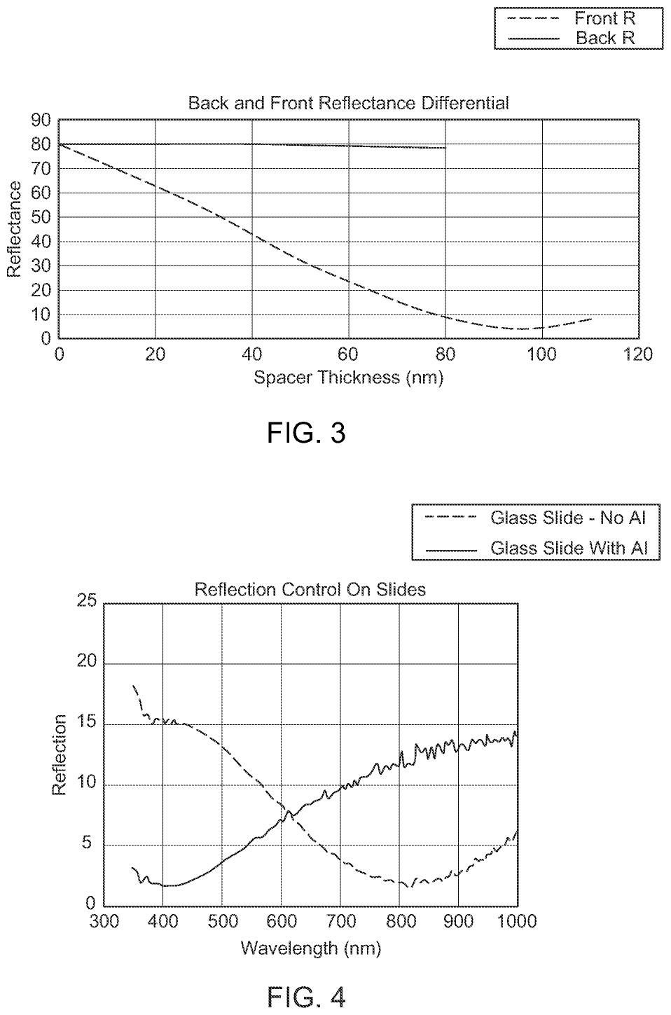

Modelling data for the back side reflection control demonstrates that by varying the thickness of the SiO₂ spacer layer in Glass\Al\NSiO₂\Zr structure, the reflection of the wire grid polarizer can be minimized. Modelling data from FIG. 3 shows that the back side in the structure of Glass\Al\SiO₂\Zr, which only has an Al coating on the glass substrate shows high reflectance of a constant value of around 80. The front side in the structure of Glass\Al\SiO₂\Zr comprises reflection control coating of SiO₂\Zr on the Al grids. With increasing thickness of SiO₂ between 0 to 120 nm and at fixed 5 nm thickness of Zr layer, the front side reflectance of the wire grid polarizer reduces from about 80 to below 5.

In some examples of the present specification, the theoretical concept of the coating layer obtained by the modelling data in FIG. 3 is applied on a wire grid polarizer structure that uses Al grids on a glass substrate. The coating is applied at normal incidence in a small sputtering machine. The goal is to assess if additional high absorbing layer(s) coating on the Al grids, as predicted in the modelling data in FIG. 3, is a viable approach to reduce the reflection in aluminized areas while maintaining sufficient overall transmission.

In some examples, the structure in the coating comprises substrate and varied thicknesses of SiO₂\Zr\SiO₂ reflection control layer. In some embodiments, the thicknesses of individual metal or metal oxide in the reflection control layer include but is not limited to substrate\70 nm SiO₂\7 nm Zr\65 nm SiO₂. In the reflection control layer, the top SiO₂ layer provides an additional reduction in reflection.

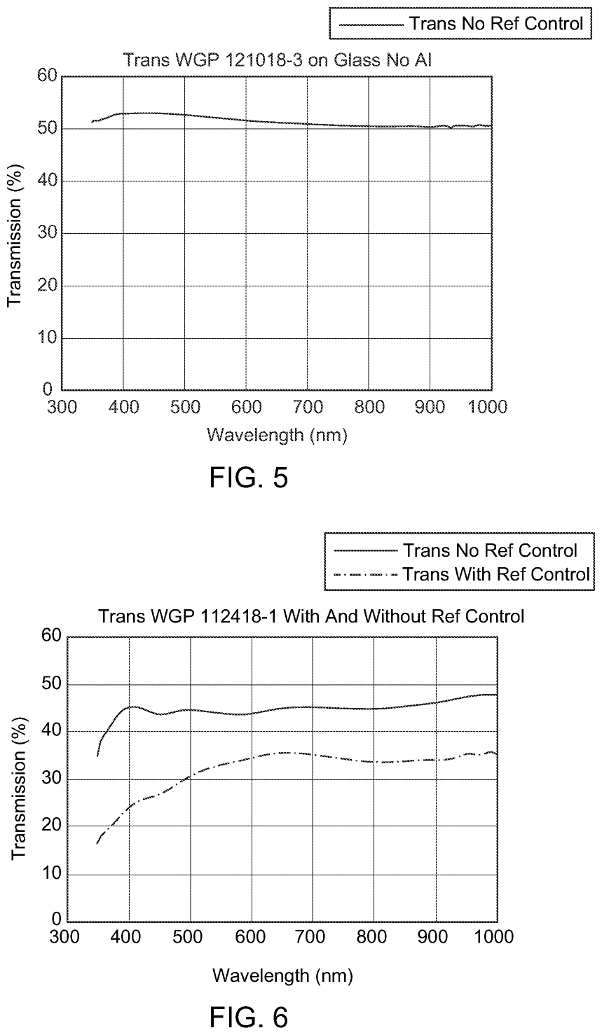

The reflection and transmission spectra for this design coated on glass are shown in FIGS. 4 and 5. As can be seen from FIG. 4, When there is no Al on the glass slide, the reflection spectra of the glass slide\70 nm SiO₂\7 nm Zr\65 nm SiO₂ coating layer increases from about 2% to 15% in the visible region. On the other hand, when

Al on the glass slide is coated with reflection control layer, for example, 70 nm SiO₂\7 nm Zr\65 nm SiO₂ layer, the reflection of the glass slide-Al\70 nm SiO₂\7 nm Zr\65 nm SiO₂ decreases from about 18% to 2% in the visible region. The difference in the spectra for reflection measured through the glass or the surface of the glass is due to the refractive index of the glass relative to air on the opposite side and is expected. FIG. 5 shows the transmission spectrum of the glass slide and reflection control layer, i.e., glass slide\70 nm SiO₂\7 nm Zr\65 nm SiO₂ layer (no Al on the glass slide) reduces to a nearly constant value of about 50% in the visible region.

The reflection and transmission spectra performances of glass substrate and reflection control layer and glass substrate and Al and reflection control layer obtained from FIGS. 4 and 5 are applied on a wire grid polarizer and the results are summarized in FIGS. 6-8. In some examples, the coating layers are embedded in a laminate, which includes but not limited to polyurethane or urethane adhesive laminate or the imprint material. Embedding the layers in a laminate is important because the adhesive or the imprint material becomes the incident media and not the air. The refractive index of the adhesive or the imprint material are nearly close to 1.5 which is greater than air.

FIG. 6 shows a transmission spectrum with the reflection control layer (i.e., 70 nm SiO₂\7 nm Zr\65 nm SiO₂ layer) or without the reflection control layer. As can be seen from FIG. 6, the transmission increases from about 35% to about 48% in the visible region, when the Al wires of the grid polarizer do not include the reflection control layer. FIG. 6 also shows that when the Al wires of the grid polarizer include the reflection control layer, there is a smaller increase in transmission from about 15% to about 35% compared to the transmission spectra when no reflection control layer present on the Al wires. It can be concluded from the transmission spectra in FIG. 6 that the transmission of the wire grid polarizer with the reflection control layer is reduced due to the absorption of the incident light in the high absorbing Zr layer.

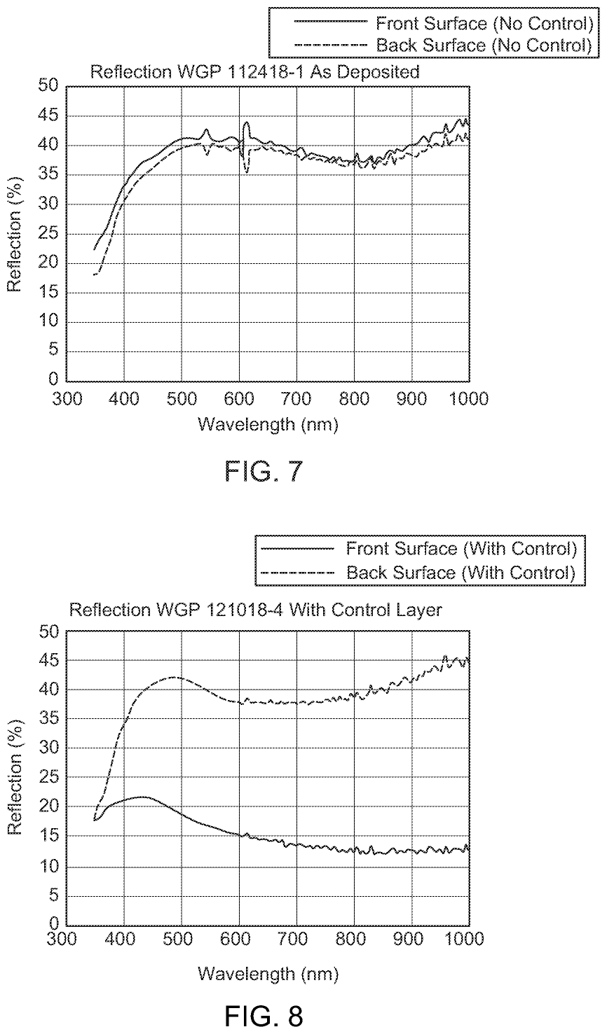

FIG. 7 shows the reflection spectra of the wire grid polarizer when the front surface and the back surface comprise no SiO₂\Zr\SiO₂ reflection control layer. The near superimposition of the reflection spectra when the front surface and the back surface comprise no SiO₂\Zr\SiO₂ reflection control layer emphasizes the importance of the reflection control layer in reducing the reflection both on the front and the back surface of the wire grid polarizer.

FIG. 8 shows reflection spectra of the back surface (Al only) and the front surface (Al and reflection control layer) of the wire grid polarizer. In the back surface, i.e., Al surface through polyurethane laminate, the reflection increases from about 18% to about 45% in the visible region. However, for the front surface, the reflection reduces from about 18% to about 12% when the front surface comprises Al and reflection control SiO₂\Zr\SiO₂ layer. In some examples, the reflection is reduced by a factor of 3-4 through most of the visible region.

The key factor that determines the performance of a wire grid polarizer is the relationship between the center-to-center spacing, sometimes referred to as period or pitch, of the parallel grid elements and the wavelength of the incident light. The dimension of period or pitch between parallel grid may decrease if the thickness of the grids increases. A limitation of the reflection control layer of 70 nm SiO₂\7 nmZr\65 nm SiO₂ described above is the required layer thickness of the coating and related complexity. The SiO₂\7 nm Zr\65 nm SiO₂ reflection control layer requires at a minimum two additional materials with a combined thickness of about 140 nm of the reflection control layer. This thickness is larger than the required dimension of the period of the wire grid polarizer structure. Therefore, the reflection control layer of 70 nm SiO₂\7 nm Zr\65 nm SiO₂ may not be incorporated at an angle on top of the Al grids which would help to recover a portion of the transmission. Hence, an alternate reflection control coating is needed in which thickness of the coating is smaller than the period of the wire grid polarizer and the reflection control layer can be incorporated at an angle on top of the Al grids.

Nature Materials; Vol 12; 2013 by M. Kats et. al., which is incorporated herein in its entirety by reference, has used highly absorbing non-metallic layers to reduce the reflectivity of the Al grids in a wire grid polarizer. According to some examples of the present invention, an alternate reflection control coating comprising non-metallic layer includes but not limited to ZrOₓN_{y}. ZrOₓN_{y} is selected since the material can be modified from reflective metal nitride, like ZrN, absorbing metal oxynitride, like ZrOₓN_{y} and transparent metal oxide, like ZrOx.

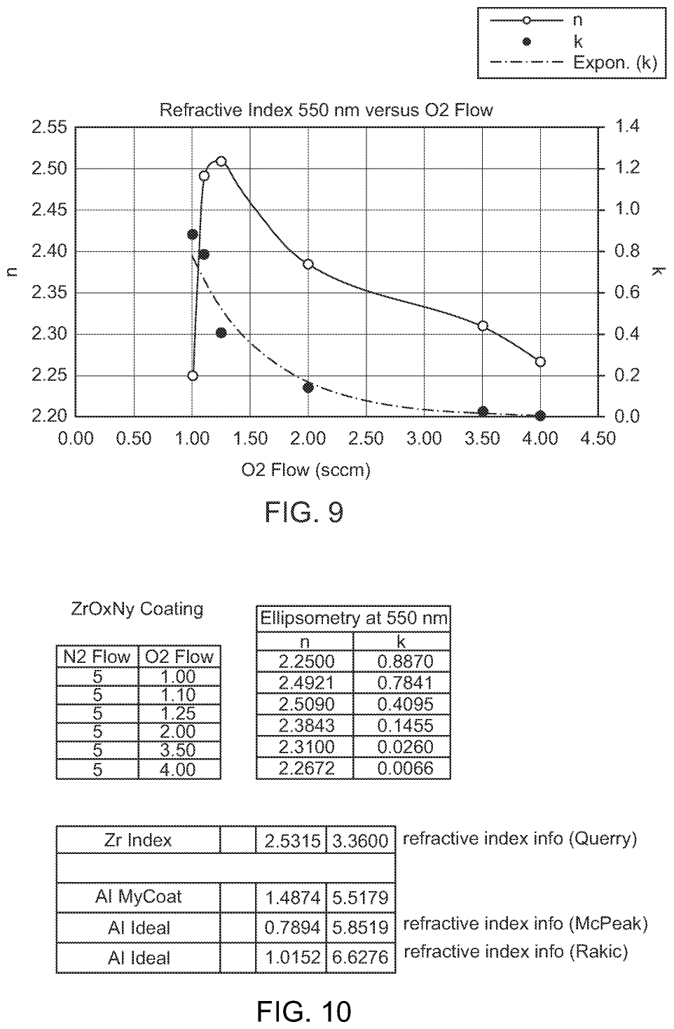

The optical properties of the highly absorbing ZrOₓN_{y} layer have been evaluated by depositing all the films in sub stoichiometric and/or towards the metallic side of the compositions. The resulting refractive indices (n) and extinction coefficients (k) are shown under different oxygen flow rates in FIG. 9. FIG. 10 shows the important refractive indices (n) for modeling considerations. Based on the modelling data, the n value for Al-My coat (SiO₂\Zr\SiO₂ coating) is 1.4874. Whereas the n values of ZrOₓN_{y} are much higher (greater than 2.0) than Al-My coat under different nitrogen and oxygen flow rates. Hence, based on the n values, high absorbing ZrOₓN_{y} coating on the Al grids is a better option as a reduction control layer for the Al grids.

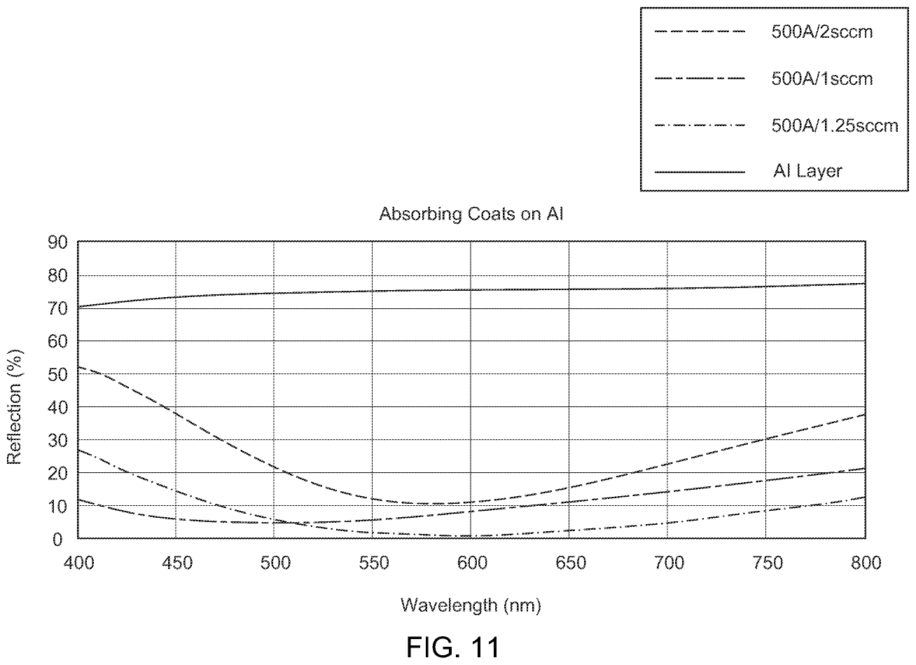

Using the above n data, stacks of ZrOₓN_{y}/Al/ZrOₓN_{y} are assembled on glass slides. The purpose of this coating assembly is to examine the reduction of the reflectance by the coating layers under different conditions, for example, using different thickness of the ZrOₓN_{y} and under different oxygen flow rates. A sample of the resulting data set is shown in FIG. 11. In FIG. 11, glass slide-Al was used as a control and a reflection of about 70% to about 78% was obtained for the glass slide-Al. The high reflection data for glass slide-Al was the result of the absence of any reflection reduction layer coated on the Al grids. It can be further seen from FIG. 11 that the stacks of ZrOₓN_{y}/Al/ZrOₓN_{y} are seen to substantially reduce the reflection of the incident light. The lowest reduction of the reflection is achieved when the thickness of the ZrOₓN_{y} was 550A under a gas flow rate of 1.25 sccm. The reflectance of these ZrOₓN_{y}/Al/ZrOₓN_{y} stacks can be as low as 3.61 (luminous reflectance) when measured through the glass slide. Measuring through the glass is a simulated match to the appearance through a laminate structure surrounded by PUA and urethane adhesive. The coating thickness in ZrOₓN_{y}/Al/ZrOₓN_{y} is 145 nm which considers reflection control from both front and back surface reflections. This is half the thickness of the metal dielectric reflection control layer of SiO₂\Zr\SiO₂ and also exhibits improved performance of reduction in reflection.

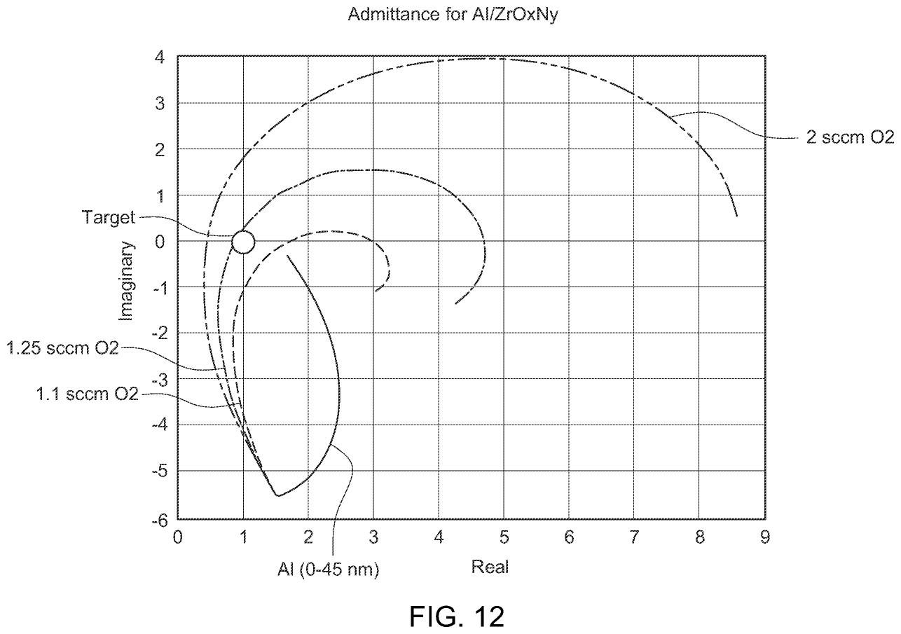

Thin-Film Optical Filters; IOP Publishing; 2001 by MacLeod, the content of which is hereby incorporated in its entirety, shows how the admittance of a coated layer is calculated based on the refractive indices of coating layers. Using the refractive index data from FIG. 10, modeling of the admittance of the coating stack ZrOₓN_{y}/Al/ZrOₓN_{y} was performed in Matlab to better understand the results. FIG. 12 shows the optical admittance diagram for ZrOₓN_{y}/Al/ZrOₓN_{y} coating. As can be seen from FIG. 12, the index corresponding to a gas flow of 1.25 sccm oxygen passes closest to the target value for optical admittance.

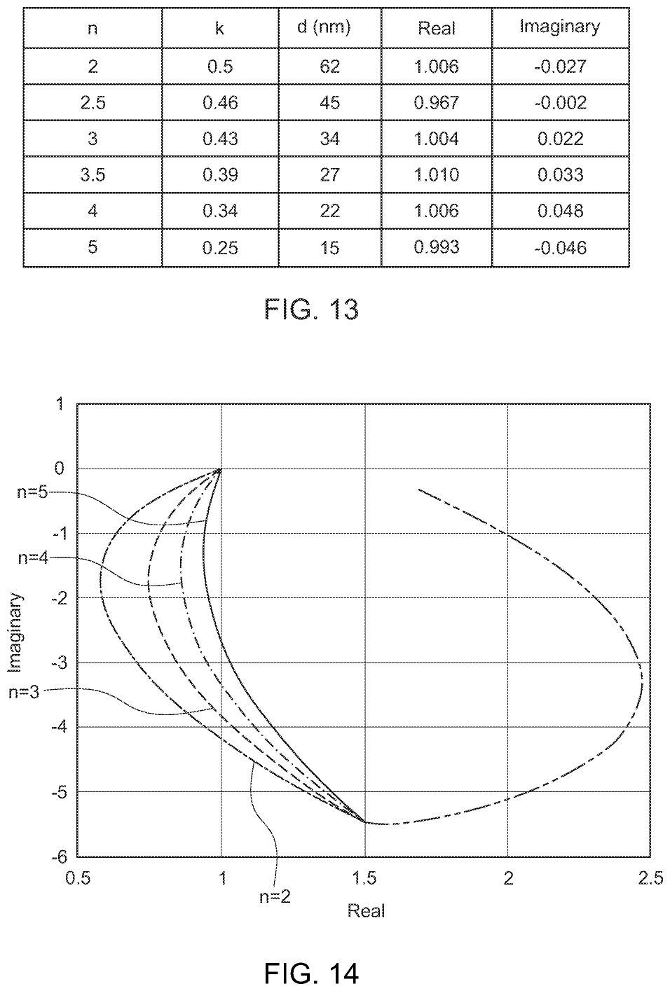

To optimize the performance of the reflection control layer, it is important to consider the effect of the refractive index on reducing the thickness of the reflection control layer. Hence, using the admittance calculator, the combination of the extinction coefficient and required thickness to minimize the reflection from an Al layer were back calculated. The back calculations of the extinction coefficient (k) and thickness (d) are summarized in FIG. 13. It can be seen from the last row in the table in FIG. 13 that to obtain the lowest value of the coating thickness on top of the Al layer, a coating material with as high refractive index as possible is needed. In FIG. 13, calculation shows that to achieve the lowest value of 15 nm coating thickness, the required refractive index value is 5.

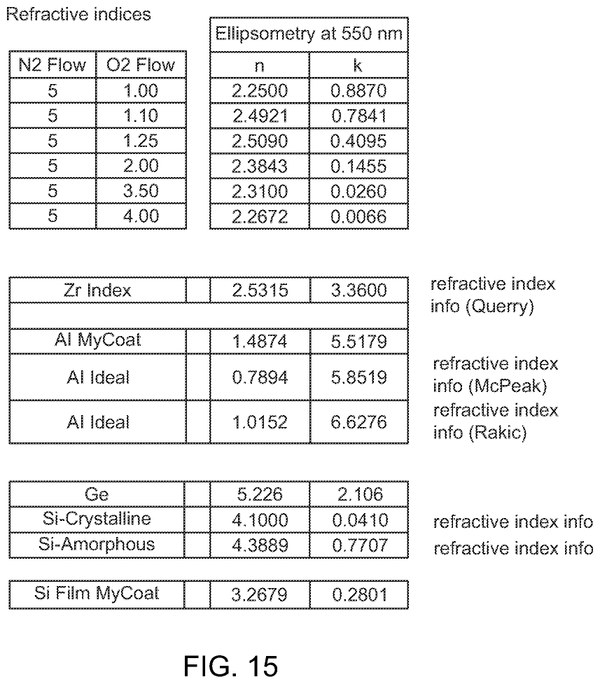

FIG. 14 discloses admittance trajectories for different refractive indices. FIG. 14 also confirms that a coating layer with high refractive index is needed to reduce the thickness of the reflection control layer. Based on the modelling data of FIGS. 13 and 14, it was decided to pursue high refractive index absorbing materials as a reflection control layer. Several materials were considered and shown in the table in FIG. 15.

It can be seen from FIG. 15 that a good choice of material is Germanium (Ge) due to the high refractive index of 5.226. However, the extinction coefficient (k, 2.106) of Ge is higher than the desired value based on the admittance calculations in FIG. 13 that showed the desired extinction to be nominally 0.25. It is therefore important to see what the refractive index of the Ge films deposited on Al grids by E-Beam evaporation are in reality. The incorporation of background oxygen and porosity is expected to have some impact on the refractive index of Ge.

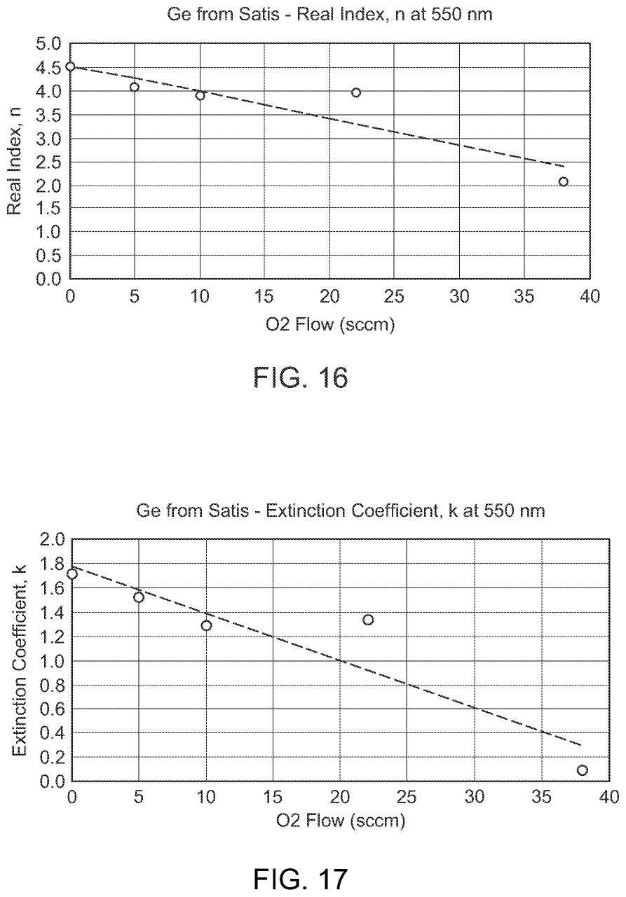

FIGS. 16 and 17 show real refractive index (n) and extinction coefficient (k) data when the Ge films are deposited on Al grids by E-Beam evaporation and the n and k values were measured under different oxygen flow rate and a coating thickness of 550 nm of Ge layer. It can be seen from FIGS. 16 and 17 that the highest refractive index of Ge is approximately 4.5 with an extinction coefficient of 1.7.

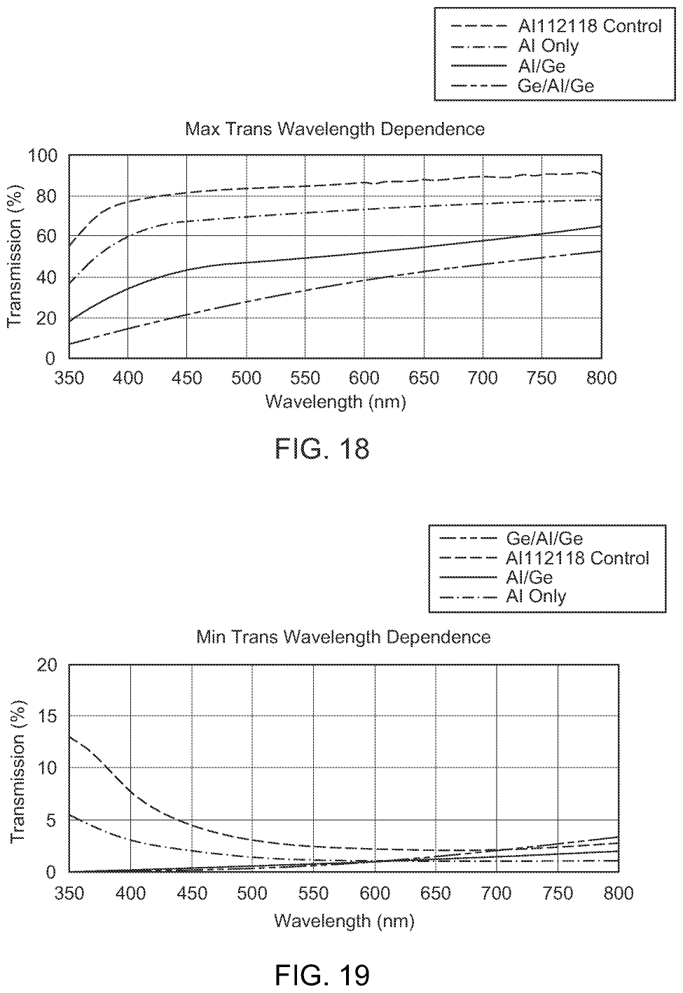

Based on the above data, a structure of Ge/Al/Ge and Al/Ge were deposited on patterned samples. A reference sample of Al only coating was also included. This was compared against an earlier prepared sample (Al 112118 Control) that had been patterned and metallized. The resulting maximum transmission and reflection spectra are shown in FIGS. 18-21.

FIG. 18 shows that the highest values of the maximum transmission were obtained for the two Al only coatings (for example, Al only and Al 112118) which were devoid of reflection control Ge coating. The two Al only coatings, however, show different levels of maximum transmission of the polarized light. The difference in maximum transmission between two Al only coatings may be attributed to the patterning or quality of the Aluminum coating. It can be also seen from FIG. 18 that the lowest value of the maximum transmission was obtained when the coating structure is Ge/Al/Ge. The maximum transmission of the coating structure of Al/Ge was higher than the coating structure of Ge/Al/Ge. The added layer of Ge may have contributed to the lowering of the maximum transmission in Ge/Al/Ge. As can be seen from FIG. 18 that the Al only samples show an increase in maximum transmission at low wavelengths and the addition of the Ge suppresses this increase. It is further evident from FIG. 18 that the presence of two Ge in the coating structure reduces the transmission more than when the coating structure comprises one Ge.

FIG. 19 discloses the minimum transmission values of the two Al only coatings which were used as control and the coating structures of Ge/Al/Ge and Al/Ge. It is clear from FIG. 19 that the minimum transmission drops for the Al only control coatings at lower wavelengths. The coating structure of Ge/Al/Ge shows slight increase in minimum transmission compared to the minimum transmission spectra of Al/Ge.

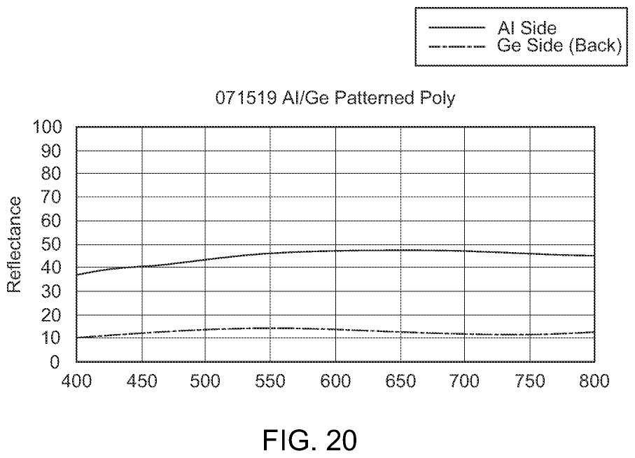

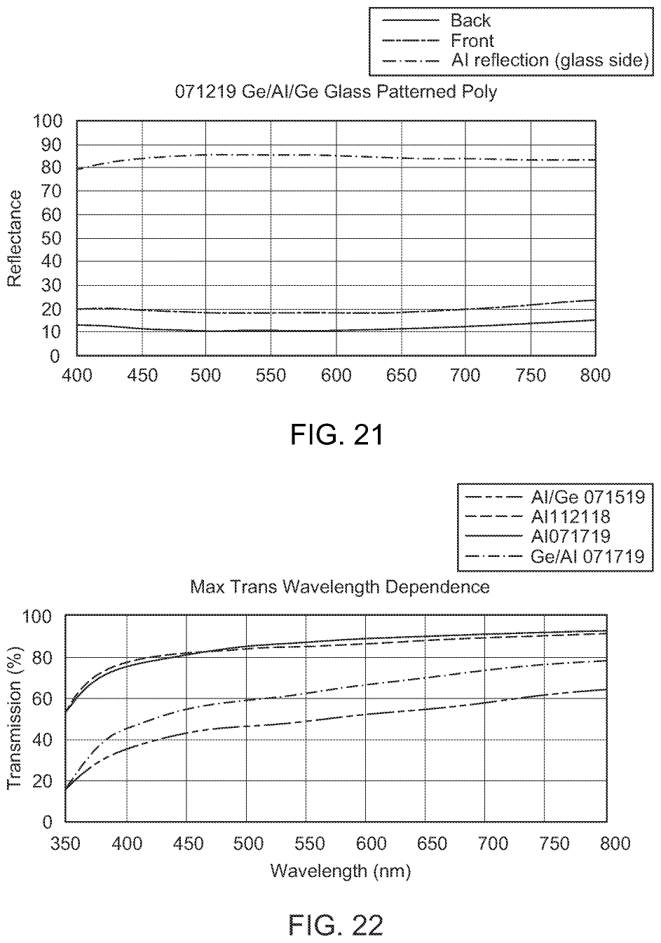

FIGS. 20, 21 show reflectance spectra of the coating structures of Ge/Al/Ge and Al/Ge. It is to be noted that in the Al/Ge coating, Ge is present in the back side of the coating, i.e., the side facing the wearer's eyes. FIG. 20 shows the reflectance of Al/Ge coating. The Al-side, the side facing the observer, shows much higher reflectance, whereas, Ge side, the side facing the wearer's eyes shows much smaller reflectance compared to the Al-side. In some examples of the present invention, this coating structure will minimize reflection into the eyes of the wearer but provide a mirror like appearance to an observer. According to some examples, this coating structure can be used to reduce reflection but can also be used to impart a specific color or appearance in reflection by choosing an appropriate thickness.

FIG. 21 shows reflectance of the coating structure of Ge/Al/Ge from front and back sides using the glass slide-Al as a reference. The Ge layer reduces the reflection by a factor of 3.5. The reduction is larger (greater than 4) when looked at through the polycarbonate film and PUA in which the coating structure of Ge/Al/Ge is embedded in a PUA or polycarbonate laminate. This is more indicative of the final appearance in a laminate form. Since the reflection measurements include the reflection of the polycarbonate (for back surface measurements), the back surface reflection is increased by 5%. Hence, it can be concluded from the reflection data of FIGS. 20 and 21 that the reflection reduction works quite well in the coating structure of Ge/Al/Ge.

The reduction in transmission for the coating structures of Ge/Al/Ge and Al/Ge is problematic as shown previously in the maximum transmission spectra in FIG. 18 and minimum transmission spectra in FIG. 19. To understand the reduction of transmission for the Ge/Al/Ge and Al/Ge, first, the Al quality was investigated, and the quality appears to cause a general reduction in the transmission when compared against the previous control. To improve the quality of Al, the deposition conditions were modified by decreasing the angle and thickness of the deposition. The resulting transmission scans for patterned Al under these conditions is substantially improved and shown in FIG. 22. FIG. 22 shows that the transmission pattern quality of the Al only coating matches with the control coating Al 112118.

FIG. 22 further shows a comparison of the two Al deposition conditions, one with Ge present on the outside of the Al (Ge/Al, sample no. 071719) and the other with Ge present on the back side of the coating stack (Al/Ge, sample no. 071519). The transmission for Ge/Al shows substantial increase with Ge present on the outside of the Al. However, the transmission value is still lower than the Al only samples. The cause for this lower value of transmission of Ge/Al layer in comparison to the Al only samples may stem from that fact that the total layer thickness being comparable to the spacing between pillars allowing coupling.

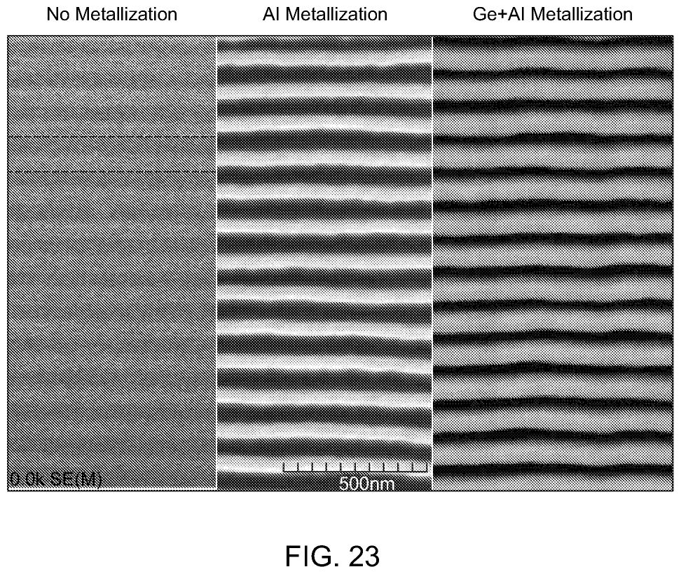

To understand further the lower value of transmission of Ge/Al layer in comparison to the Al only samples, SEM imaging was performed of the samples. SEM imaging will also help to better understand the mechanisms for reflection reduction. Three samples were compared: (i) a replicate with no metallization or coating (bare pattern); (ii) an aluminum coated sample; and (iii) a sample coated with Ge and Al. SEM images of these samples are shown FIG. 23. The samples in ii) and iii) correspond to sample nos. 071719 (Al only) and 071719 (Ge/Al) as disclosed in FIG. 22.

The SEM imaging of FIG. 23 clearly shows that while the Al thickness between Al coated sample (ii) and Ge/Al coating (iii) is held constant, however, in Ge/Al layer, there is a reduction of spacing between the adjacent grids with increased coating thickness of Ge and Al together.

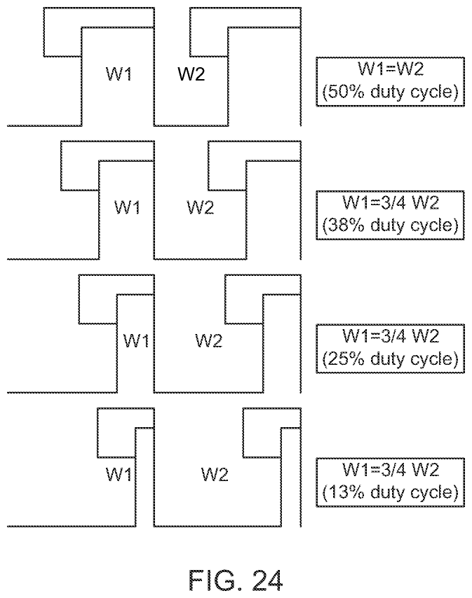

To overcome the issue of reduction of spacing between the adjacent grids, the duty cycle of the pattern may be modified, while the period of the pattern is held constant. Duty cycle can be defined as ratio of the pillar width to the total period of the pattern. By decreasing the duty cycle the spacing between pillars can be increased. This is shown schematically for four duty cycles in FIG. 24. In FIG. 24, the dark shaded areas on top of the pillars represents the applied coating. W1 is the pillar width and W2 the spacing between pillars. Increasing the spacing between pillars increases the spacing between wires. The Ge/Al pattern shown in FIG. 22 for the SEM imaging is 50% duty cycle. It is clear from FIG. 24 that with gradual decrease of the duty cycles from 50% to 13%, the spacing between the pillars (W2) and the spacing between the wires increases. This increase in spacing between adjacent wires will allow the incorporation of an additional Ge layer to the Ge/Al structure and hence, the reflection control coating structure of Ge/Al/Ge can be used while mitigating unwanted reductions in transmission or efficiency.

### Optimization of Ge/Al Layers for Reflection Control:

To better understand the possible master designs of the reflection control coatings, it is necessary to figure out the required thicknesses of the Ge and Al layers in order to realize the minimum reflection. While it is known to those ordinary skill in the arts that it is possible to find out the thicknesses of the Ge and Al layers through computer modelling, it is, however, not possible to predict the exact index of the Ge and Al layers or possible interfacial mixing that may occur from the computer modelling. It is therefore necessary to perform a Design of Experiments to determine the optimized conditions. The Design Experiments of the coatings (Ge and Al layers) were performed on a flat glass slide (unpatterned) and the transmission and reflection measured from the back surface of the glass. In such an arrangement the goal is to minimize both the reflection and also the transmission.

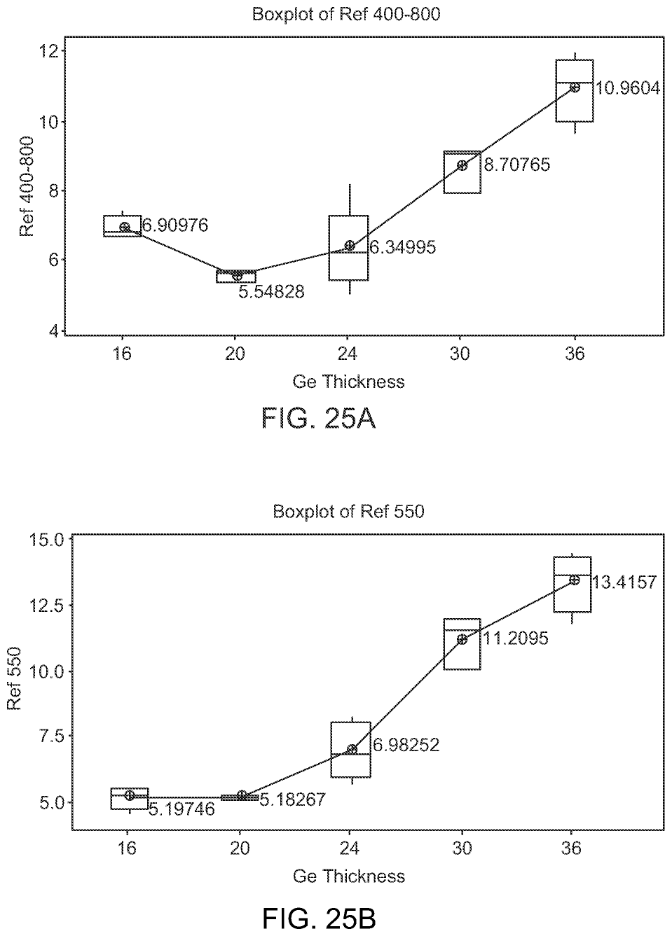

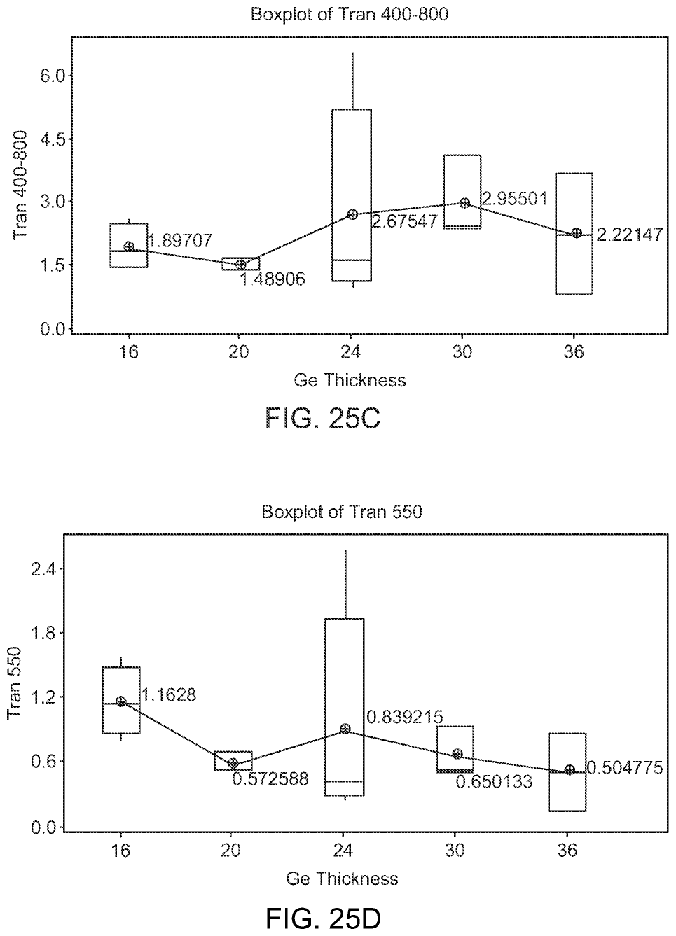

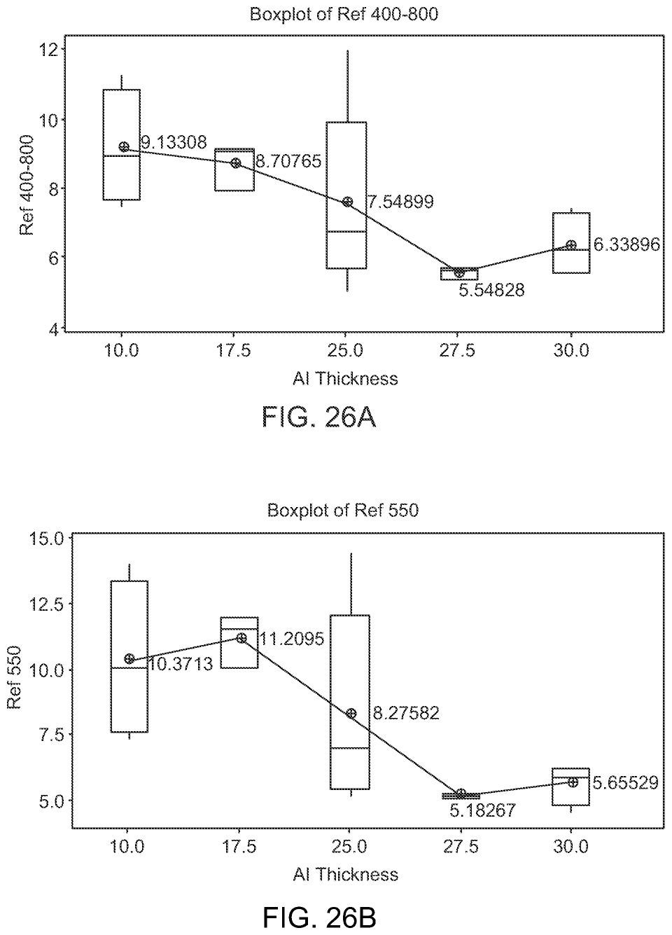

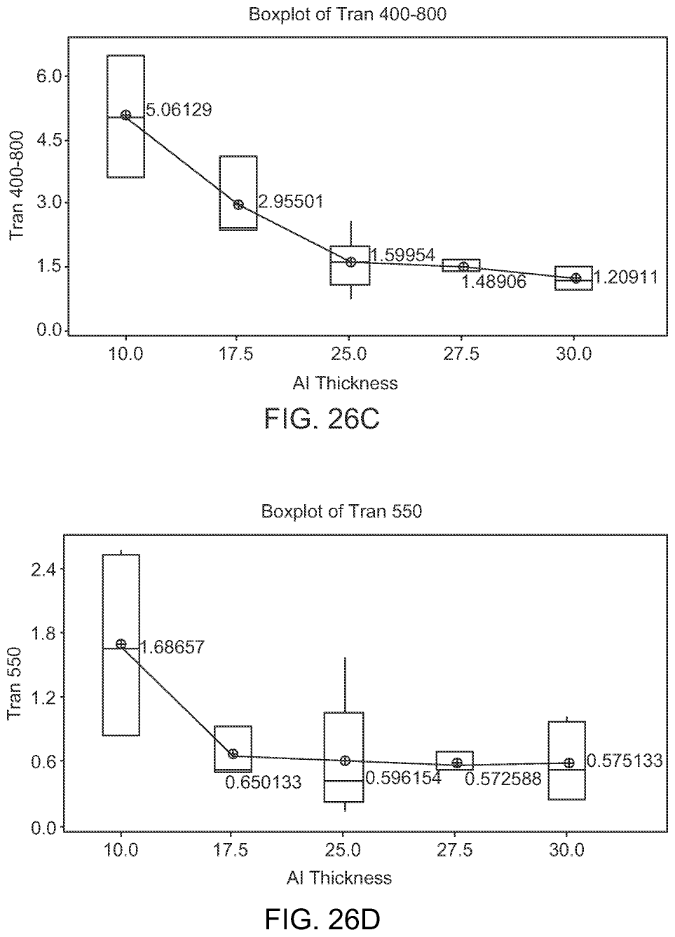

The Design Experiments of the Ge-glass slide and Al-glass slide were performed varying the Ge and Al thickness from 16-36 nm for Ge and 10-30 nm for Al. The important metrics in the Design Experiments are transmission and reflection. Results are shown in FIGS. 25A, 25B, 25C, 25D and 26A, 26B, 26C, 26D. The transmission and reflection spectra for the Ge-thickness ranges (FIGS. 25A, 25B, 25C, 25D) and Al-thickness ranges (FIGS. 26A, 26B, 26C, 26D) are expressed in two ways—the average from 400-800 nm and specifically at 550 nm.

From the data in FIGS. 25A, 25B, 25C, 25D, it is clear that the target Ge thickness is nominally approximately 20 nm to achieve lowest reflection and transmission. From the data in FIGS. 26A, 26B, 26C, 26D, it is clear that the target Al thickness is about 27.5 nm to achieve lowest reflection and transmission. Therefore, the total thickness of the coating stack is 47.5 nm for a single surface Ge/Al reflection control. In some examples, such single surface Ge/Al reflection control may function as a polarized mirror sun lens. The total thickness of the coating stack is 67.5 nm for dual direction reflection control (Ge/Al/Ge). The average reflection is below 6% under these optimized conditions. Removing the back surface reflection of the glass slide, which is 4%, in some examples of the present specification, the average reflection is only 2%. Furthermore, for a WGP the reflection is only half this value or 1%. According to some examples, under such conditions, the transmission is still low with a value of about 1.5% under 400-800 nm. According to some examples, optimization of the thicknesses of the coated layers provides a polarization efficiency of greater than 90% and preferably greater than 95%.

In some examples, the use of a high index/Al/high index stack is capable of reducing the reflection from a WGP from between 40-50% to between 5-10%. Further reductions below 5% may be possible with refined patterns and optimized material selection based on the refractive index and extinction coefficient.

In some examples of the present specification, the high refractive index material is used to form a quarter wave layer. The desired refractive index for the high refractive index material is greater than 3 with extinction coefficients above 0.20. In some examples, the desired high refractive index materials include but not limited to Ge, Si and alloys of these materials.

The coating structure in a wire grid polarizer can reduce the spacing between pillars (and therefore wires) in the wire grid. This will reduce the performance of the polarizer (decreases in transmission and/or polarization efficiency, and greater wavelength dependence). In some examples of the present specification, increase in the spacing between pillars by applying duty cycles increases the spacing between wires and improves the performance of the wire grid polarizer.

In some examples of the present specification, the coated stack of the wires can be used to impart a specific color or appearance in reflection by choosing an appropriate thickness in addition to reducing the reflection. This could create the appearance of a colored mirror on one side and then low reflection on the back.

As stated previously, the colored mirror like appearance of the wire grid polarized optical lenses can be aesthetically pleasing, and hence, desirable. The mirror layer of the wire grid polarizer may be laminated with a transparent colored film to protect the mirror coating from abrasion and environmental damages. Laminating the mirror finished wire grid polarizer layer with a transparent colored film of choice to form a colored mirror finish wire grid polarizer may even be more aesthetically pleasing, desirable and may have higher market demand.

Existing technology to apply a colored mirror finish to a lens uses a batch sputtering or vacuum deposition processes. The vacuum deposition processes are expensive, mainly because the economy of a large-scale production cannot be accessed in this process. Also, the resulting product, produced through the vacuum deposition process, has the mirror layer deposited as the top layer on the surface. Hence, the mirror layer is exposed to the abrasions and other hazards inherent in the use, transportation, and storage of the optical lenses. There are additional limitations to traditional vacuum deposition methods, particularly in that the process is challenging to apply a silver mirror, which is a commercially desirable option.

To overcome the limitations of the traditional vacuum deposition process and to produce large scale mirror finished wire grid polarizer, the present specification utilizes a vapor deposition process to form the wire grid polarizer with a mirror finish. To cover the mirror layer from scratches, the mirror finish wire grid polarizer is laminated in a stack with a transparent and colored film of choice. This results in a colored, mirror finished polarized layer, wherein the mirror layer is protected from abrasions and other hazards with the colored layer and the color of the colored layer is limited only by the availability of different film colors. This colored film laminated wire grid polarizer geometry is amenable to roll-to-roll processing, which can rapidly produce a large volume of colored, mirror finished, wire grid polarized laminate suitable for molding into lenses. The colored wire grid polarized laminate produced by this method is suitable for subsequent application of additional anti-scratch coating(s). Hence, in the following sections, the present specification describes some non-limiting examples of a colored film laminated, mirror finished, wire grid polarizer of an optical lens.

U.S. Pat. No. 10,838,128 B2, the content of which is incorporated in its entirety by reference, discloses the formation of wire grid polarizers that polarize electromagnetic radiation in the visible range on an ophthalmic or optical article, such as a lens, a film, or a film laminate. This reference discloses that the structured surface of a lens, a film, or a film laminate may employ a system of linear patterns or features, such as peaks and valleys, ranging in the scale of nanometers to hundreds of nanometers to form the wire grid polarizer.

Following the same basic design as shown in U.S. Pat. No. 10,838,128 B2, in some examples of the present specification, the wire grid polarizers may be formed on a patterned or structured surface of a lens, a film, or a film laminate. In certain examples, materials for the patterned or structured surface of a lens, a film, or a film laminate may include but not limited to polycarbonate, polyurethane acrylate, or polyurethane.

In certain examples of the present specification, once the film, lens, or laminate has been formed with a structured or patterned surface and the composite wires of the wire grid polarizer are generated on the patterned surface, additional layers or coatings, for example, a colored film layer, a mirror coating or hard coatings and/or anti-reflective coatings, may be laminated or applied to the structured surface so as to embed the wire grid polarizer and provide physical and environmental protection for the polarizer.

Among these additional layers or coating which may be applied on the structured surface of the film, lens, or laminate, laminating a mirror coated wire grid polarizer with a transparent colored film of choice to form a colored mirror finished wire grid polarizer is very much desirable because of its aesthetic appeal.

In some non-limiting examples, the colored film laminated wire grid polarizer may be laminated with at least one additional protective layer, for example but not limited to, a polycarbonate layer or may be laminated between two additional protective layers, for example, two polycarbonate layers.

According to some other examples of the present specification, once the film, or laminate has been formed with a structured or patterned surface and the composite wires of the wire grid polarizer are generated on the patterned surface, a functional photochromic layer, for example, an adhesive layer with one or more photochromic dyes, may then be deposited and laminated with a base film layer, for example, a polycarbonate layer, so as to embed the wire grid polarizer in a laminate structure. The photochromic laminate may then be employed to form a polarizing optical article having the inventive wire grid polarizer and can be molded through injection molding or casting to form the laminate lenses, for example a single or multifocal ophthalmic lens. In some examples, the photochromic layer or adhesive may comprise but not limited to a polyurethane adhesive.

In some non-limiting examples, the photochromic layer laminated wire grid polarizer may be laminated between two additional protective layers, for example, two polycarbonate layers. In some examples, the photochromic layer laminated wire grid polarizer may be bonded between two polycarbonate layers by an adhesive, for example but not limited to, a polyurethane adhesive. In some examples, the protective layers may comprise the same component as the base material of the lens. In some non-limiting examples, the base material may also include polycarbonate.

In some non-limiting examples, the inventive wire grid polarizer may be formed with one sided reflection control, for example, the front side of the laminate of the polarizer (the wearer side) may be coated with a reflection control layer, for example but not limited to, a Ge layer, and a reflective layer, for example, an Al layer may be deposited on top of the reflection control layer to provide a mirror effect. The mirror layer may further be coated with an adhesive, for example, polyurethane adhesive. The adhesive layer of the mirror finished wire grid polarizer may further be laminated with a colored film to form a colored wire grid polarizer. In such arrangement, the coating layers of the wire grid polarizer may be in the order of-surface material/Ge/Al/colored film. In some examples, coating the front side of the laminate of the polarizer with a high reflection control layer means depositing a metal or composite metal component having high absorbance and refractive indices. In some examples, the high refractive index Ge layer may comprise much lower thickness and may greatly reduce the overall thickness of the colored film laminated wire grid polarizer.

In some examples, the inventive wire grid polarizer may be formed with two-sided reflection control, for example, both the viewer and wearer sides may be coated with a reflection control layer of a metal or composite metal component having high absorbance and refractive index, for example but not limited to, a Ge layer and the wire grid polarizer may be further laminated with a colored film to form a colored wire grid polarizer. In such arrangement, the coating layers of the wire grid polarizer may be in the order of surface material/Ge/Al/Ge/colored film.

In some examples, the inventive wire grid polarizer may be formed with a one-sided reflection control, for example, the wearer side may be coated with a reflection control layer of a metal or composite metal component having high absorbance and refractive index, for example but not limited to, a Ge layer and the wire grid polarizer may be further laminated with a colored film to form a colored wire grid polarizer. In such arrangement, the coating layers of the wire grid polarizer may be in the order of-surface material/Ge/Al/colored film.

In some examples, the inventive wire grid polarizer may be formed on a structured surface of a functional photochromic film with a one-sided reflection control, for example, the wearer side may be coated with a reflection control layer of a metal or composite metal component having high absorbance and refractive index, for example but not limited to, a Ge layer. In such arrangement, the coating layers of the wire grid polarizer may be in the order of photochromic layer/Ge/Al/colored film.

In some non-limiting examples, the inventive wire grid polarizer may be formed with one sided reflection control, for example, the front side of the laminate of the polarizer (the wearer side) may be coated with a reflection control layer, for example but not limited to, a Ge layer, and a reflective layer, for example, an Al layer may be coated on top of the reflection control layer to provide a mirror effect. The mirror layer may further be coated with an adhesive, for example, polyurethane adhesive. The adhesive layer of the mirror finished wire grid polarizer may further be laminated with a functional photochromic film to form a functional photochromic film laminated wire grid polarizer. In such arrangement, the coating layers of the wire grid polarizer may be in the order of-surface material/Ge/Al/photochromic film.

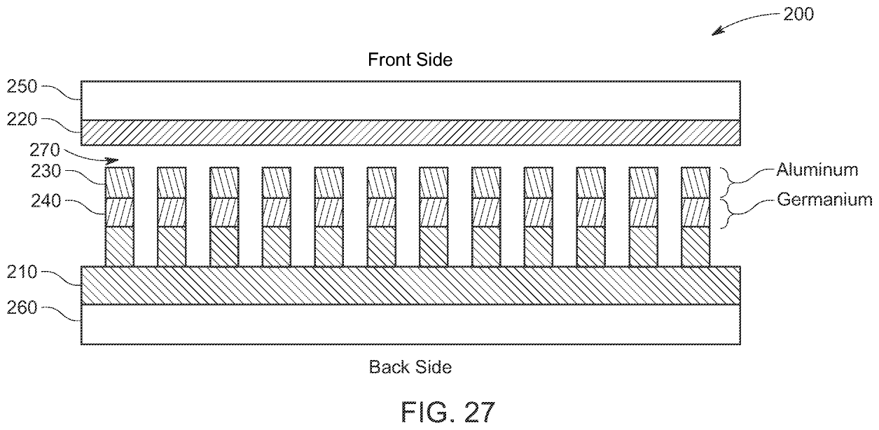

FIG. 27 illustrates one example of a laminate structure 200 of a wire grid polarizer of the present specification. As can be seen in FIG. 27, the front surface of the film 210 is patterned, and the wire grid polarizer is formed with one sided reflection control (wearer's side) and a colored film 220 is laminated on the front surface of the wire grid polarizer with an adhesive layer, for example, polyurethane adhesive layer 270. In this figure, the reflection control material (Ge) 240 is first deposited on the patterned front surface of the film 210 and the reflective Al layer 230 is deposited on top of the Ge layer to provide wearer's side reflection control with a mirror finish at the viewer's side. The mirror layer may further be coated with an adhesive layer, for example, polyurethane adhesive 270 layer. The adhesive layer 270 of the mirror finished wire grid polarizer is laminated with a colored film 220. The colored film laminated wire grid polarizer is further laminated between two additional protective layers 250 and 260, for example, two polycarbonate layers to form the laminate structure 200.

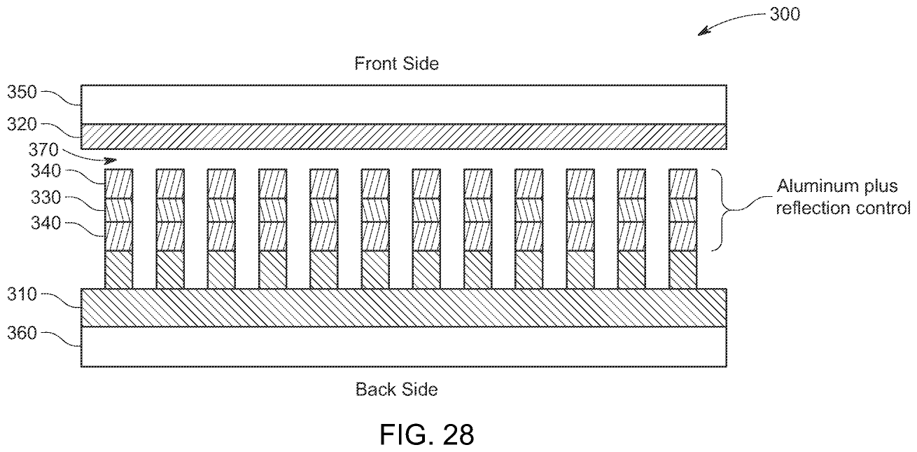

FIG. 28 illustrates another example of a laminate structure 300 of a wire grid polarizer of the present specification. As can be seen in FIG. 28, the front surface of the film 310 is patterned, and the wire grid polarizer is formed with two-sided reflection control (both the wearer's and viewer's sides) and a colored film 320 is laminated on the front surface of the wire grid polarizer with an adhesive layer 370. In this figure, the first reflection control material (Ge) 340 is deposited first on the patterned front surface of the film 310 and the reflective Al layer 330 is deposited next and the second reflection control material (Ge) 340 is deposited on top of the Al layer 330 to provide a two-sided reflection control. The top surface of the wire grid polarizer is further coated with an adhesive, for example, polyurethane adhesive 370. The adhesive layer 370 of the mirror finished wire grid polarizer is laminated with a colored film 320. The colored film laminated wire grid polarizer is further laminated between two additional protective layers 350 and 360, for example, two polycarbonate layers to form the laminate structure 300.

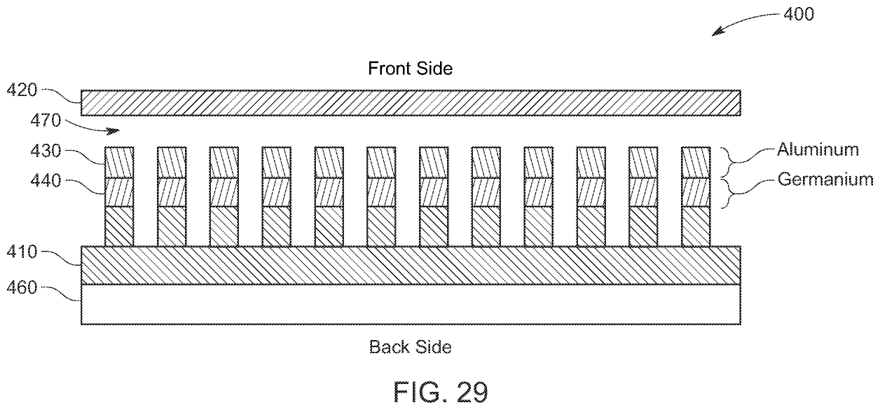

FIG. 29 illustrates another example of a laminate structure 400 of a wire grid polarizer of the present specification. As can be seen in FIG. 29, the front surface of the film 410 is patterned, and the wire grid polarizer is formed with one sided reflection control (wearer's side) and a colored film 420 is laminated on the front surface of the wire grid polarizer with an adhesive layer 470. In this figure, the reflection control Ge layer 440 is first deposited on the patterned front surface of the film 410 and the reflective Al layer 430 is deposited on top of the Ge layer 440 to provide a wearer's side reflection control with a mirror finish at the viewer's side. The mirror layer further coated with an adhesive, for example, polyurethane adhesive 470. The adhesive layer 470 of the mirror finished wire grid polarizer is laminated with a colored film 420. The colored film laminated wire grid polarizer is laminated on the back side with a protective layer 460, for example, a polycarbonate layer to form the laminate structure 400. In this example, the colored film 420 may function as a protective layer for the laminate structure 400 of the wire grid polarizer.

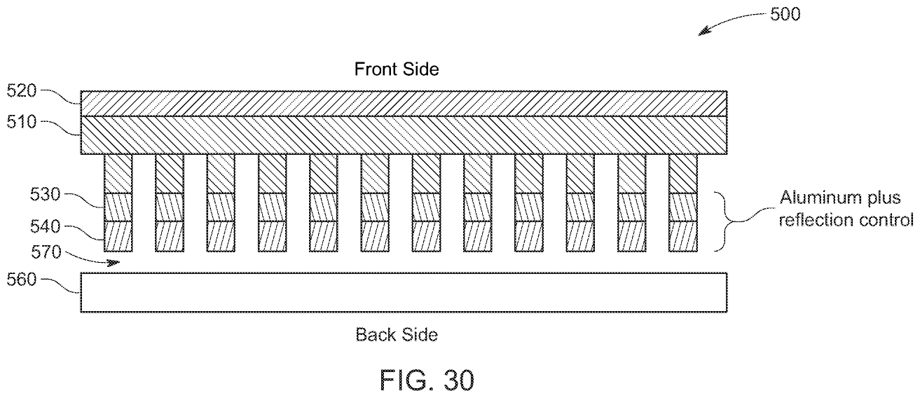

FIG. 30 illustrates another example of a laminate structure 500 of a wire grid polarizer of the present specification. As can be seen in FIG. 30, the back surface of the film 510 is patterned, and the wire grid polarizer is formed with one sided reflection control (wearer's side) and a colored film 520 is laminated on the front side (viewer's side) of the wire grid polarizer with an adhesive layer 570. In this figure, the reflective Al layer 530 is first deposited on the patterned back surface of the film 510 and the reflection control material 540 is deposited on top of the Al layer 530 to provide a back side or wearer's side reflection control. The reflection control material 540 is further coated with an adhesive, for example, polyurethane adhesive 570. The adhesive layer 570 of the mirror finished wire grid polarizer is laminated with a colored film 520. The colored film laminated wire grid polarizer is laminated on the back side with a protective layer 560, for example, a polycarbonate layer to form the laminate structure 500.

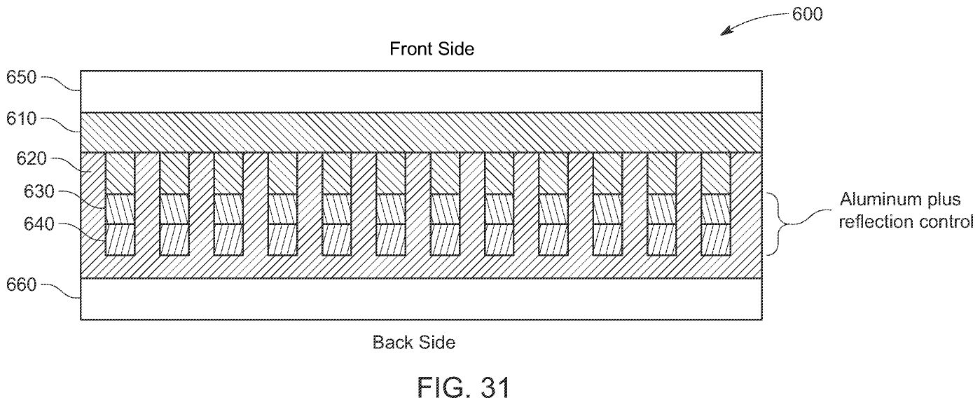

FIG. 31 illustrates another example of a laminate structure 600 of a wire grid polarizer of the present specification. In this example, the wire grid polarizer is formed with a photochromic layer instead of laminating with a colored film. As can be seen in FIG. 31, the back surface of the film 610 is patterned, and the wire grid polarizer is formed with one sided reflection control (wearer's side). In this figure, the reflective Al layer 630 is first deposited on the patterned back surface of the film 610 and the reflection control material 640 is deposited on top of the Al layer 630 to provide a back side or wearer's side reflection control. The photochromic dye and adhesive layer 620 are laminated on the backside (wearer side) with the base film layer 660 to form the laminated structure 600. In this non-limiting example, the photochromic film laminated wire grid polarizer is laminated between two protective layers 650 and 660, for example, two polycarbonate layers to form the laminate structure 600.

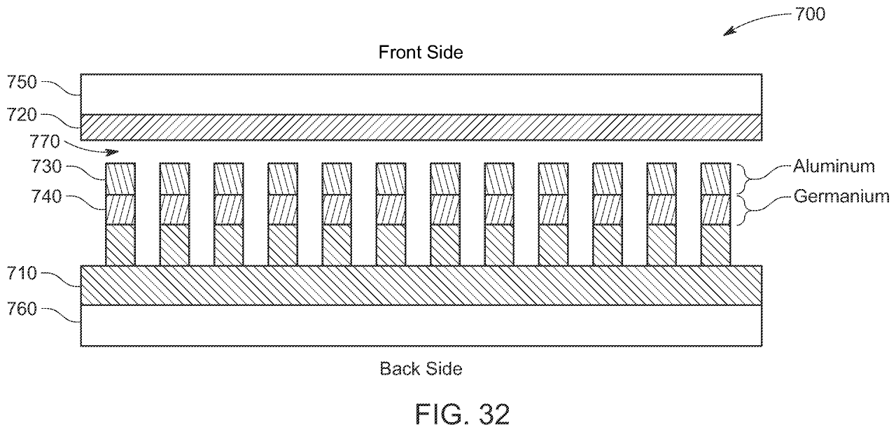

FIG. 32 illustrates another example of a laminate structure 700 of a wire grid polarizer of the present specification. In this example also the wire grid polarizer is laminated with a photochromic layer 720 instead of laminating with a colored film with an adhesive layer 770. As can be seen in FIG. 32, the front surface of the film 710 is patterned, and the wire grid polarizer is formed with one sided reflection control (wearer's side) and a functional film 720, such as, a photochromic film is laminated on the front side of the wire grid polarizer with an adhesive layer 770. In this figure, the reflection control Ge layer 740 is first deposited on the patterned front surface of the film and the reflective Al layer 730 is deposited on top of the Ge layer 740 to provide a wearer's side reflection control with a mirror finish at the viewer's side. The mirror layer further is coated with an adhesive layer 770, for example, a polyurethane adhesive layer. The adhesive layer 770 of the mirror finished wire grid polarizer is laminated with a colored film 720. The photochromic film laminated wire grid polarizer is laminated between two additional protective layers 750 and 760, for example, two polycarbonate layers to form the laminate structure.

In some examples, the thickness of the transparent colored film in the laminate may be in a range of 0.1 to 0.4 mm. In some examples, the thickness of the functional photochromic film in the laminate may be in a range of 10-50 microns.

In all the above examples illustrated in FIGS. 27-32, for the sake of clarity, the linear features of the layers of the laminate are shown as if magnified and are not shown to scale relative to the actual dimensions of the laminate.

In some examples of the present specification, the non-limiting examples of the colors chosen for the colored films which are laminated on the wire grid polarizer may include blue, red, green, yellow and lavender. In some examples of the present specification, some of the colored film laminated wire grid polarizers show comparable % of transmission in the visible range (400-790 nm) in comparison to the wire grid polarizer without any laminated colored film. In these examples, the reflection control structure of the wire grid polarizer laminated with the colored film is based on Ge and Al layers.

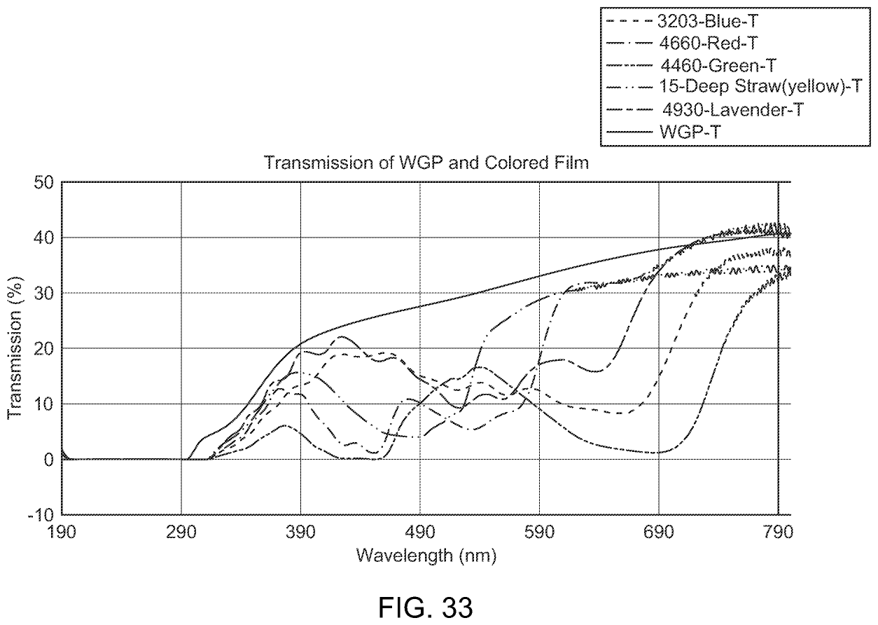

As can be seen from FIG. 33, the wire grid polarizer without any laminated colored film may have % of transmission between 20-40% within a range of 380 to 790 nm. Whereas the blue colored film laminated wire grid polarizer may have about 18% transmittance within a range of 530 to 570 nm and a transmittance of 35% or more beyond wavelength of 740 nm; the red colored film laminated wire grid polarizer may have more than 10% transmittance at 390 nm and a transmittance of 30% or more within a range of wavelength between 620-790 nm; the green colored film laminated wire grid polarizer may have about 15-18% transmittance within a range of 540 to 550 nm and a transmittance of 30% or more within a range of wavelength between 750-790 nm; the yellow colored film laminated wire grid polarizer may have about 16% transmittance at about 390 nm and a transmittance of 30% or more within a range of wavelength between 600-790 nm; the lavender colored film laminated wire grid polarizer may have more than 20% transmittance at about 440 nm and a transmittance of 30% or more within a range of wavelength between 670-790 nm. The high values of the % T of the wire grid polarizers laminated with the colored films may improve the dynamic range and contrast enhancement from the spectral filtering. It is, therefore, possible to obtain a high transmission of the desired wavelengths to maximize visibility and color contrast.

In some examples of the present specification, some of the colored film laminated wire grid polarizers show comparable % of reflection in the visible range (400-790 nm) in comparison to the wire grid polarizer without any laminated colored film. In these examples, the reflection control structure of the wire grid polarizer laminated with the colored film is based on Ge and Al layers.

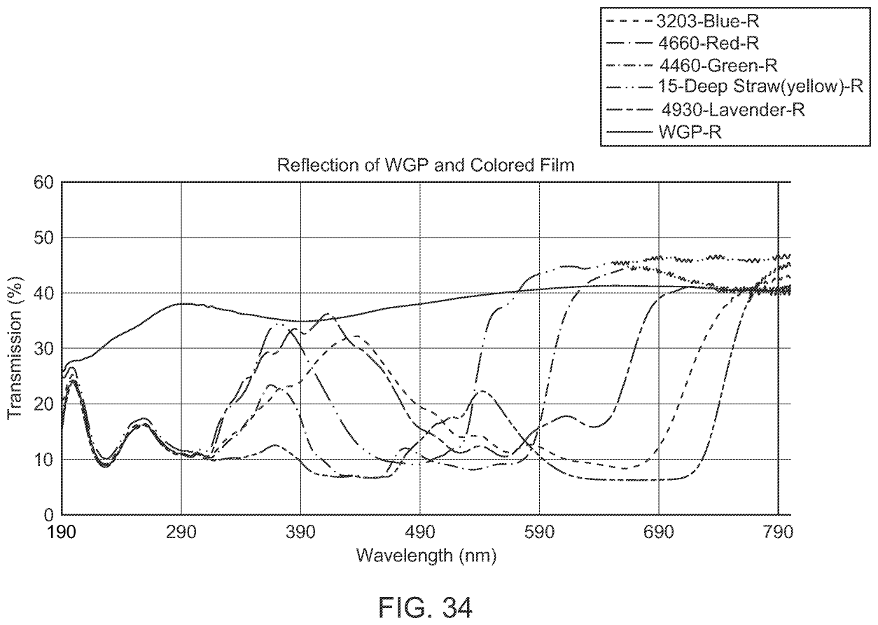

As can be seen from FIG. 34, the wire grid polarizer without any laminated colored film may have % of reflection between about 30-40% within a range of 380 to 790 nm. Whereas the blue colored film laminated wire grid polarizer may have about 30-32% reflection within a range of 420 to 460 nm and a reflection of about 40% or more beyond wavelength of 750 nm; the red colored film laminated wire grid polarizer may have more than 20% reflection at 390 nm and a reflection of 40-42% beyond 600 nm; the green colored film laminated wire grid polarizer may have about 20-22% reflection within a range of 540 to 550 nm and a reflection of 40% or more beyond 750 nm; the yellow colored film laminated wire grid polarizer may have about 30% reflection at about 390 nm and a reflection of 40-45% within a range of wavelength between 580-790 nm; the lavender colored film laminated wire grid polarizer may have more than 30% reflection at about 420 nm and a reflection of about 40% within a range of wavelength between 700-790 nm. In colored film laminated wire grid polarizer, the % of reflection controls the appearance of the mirror to the observer. The high values of the % of reflection at specific wavelengths of the wire grid polarizers laminated with the colored films may provide very vivid and vibrant colors of the polarized optical articles which are appealing.

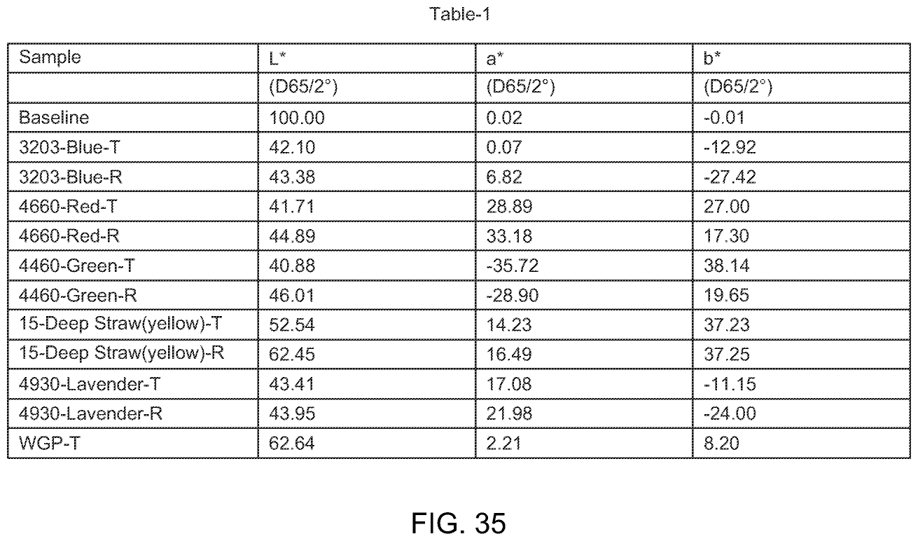

FIG. 35 illustrates table-1 that presents data of the L*, a* and b* values of the transmitted (T) and reflected (R) colors of the wire grid polarizers paired with different colored films and a reference wire grid polarizer without any laminated colored film. These data show that the transmitted and reflected colors of the wire grid polarizers paired with colored films can be changed by using different colored films. It is known that L* indicates lightness, a* is the red/green coordinate, and b* is the yellow/blue coordinate. Therefore, when the wire grid polarizer is paired with, for example, the blue film or the red film or the green film, the lightness of the blue film changes between Blue-T (42.10) and Blue-R (43.38) with Blue-R lighter than Blue-T; the lightness of the red film changes between Red-T (41.71) and Red-R (44.89) with Red-R lighter than Red-T; and the lightness of the green film changes between Green-T (40.88) and Green-R (46.01) with Green-R lighter than Green-T. Similar conclusion can be drawn when the wire grid polarizer is paired with either the yellow or lavender films. It can also be seen from table-1 that the values of the transmitted (T) colors of the wire grid polarizers paired with blue, red, green, yellow or lavender colored films are lighter than the transmission of wire grid polarizer without any colored film paring. In these examples, the appearance of the lighter colors means lower transmission of the light which may result from the presence of additional dyes in the colored films. When light passes through the colored films, some of the light may be absorbed by the dyes and thus the transmission may reduce.

In some examples of the present invention, the design of the colored film or photochromic layer laminated wire grid polarizer may allow for the appearance of the mirror of the polarizer to be tailored. For example, by having a red dye in front of the Al mirror layer, the mirror will appear to be red, and the visible light transmitted through the laminate structure will also be red. Alternatively, tints or colors may be added behind the mirror layer so the color reaching the wear's eye may be adjusted independent of the mirror color. In the present application, this gives more control than with a regular vacuum applied mirror coating obtained from the currently existing technology.

In some examples of the present invention, by embedding the silver mirror finished wire grid polarizer into the laminate with a colored film or a functional photochromic layer may protect the mirror layer from scratches. Protection of the mirror layer may be important since the scratches are very prominent on the mirror layer because of the contrast change. This creates a superior product with a distinct advantage of improved durability.

In some examples of the present invention, embedding the silver mirror coating into the laminate with a colored film or a functional photochromic layer may tailor the color of the mirror by tinting in front of the mirror layer. Existing technology to apply a mirror finish to a polarized optical lens uses a batch sputtering or vacuum coating on the front of the lens. In these existing processes, the colors of the mirror may be controlled by adjusting the vacuum coating design. However, in the present application, the silver mirror may be attached to different tinted films or adhesives layers containing photochromic dyes to control the appearance of the mirror.

Although the invention has been described in terms of particular examples and applications, one of ordinary skill in the art, in light of this teaching, can generate additional examples and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. A laminate for an optical lens, comprising:
a wire grid polarizer having at least one high refractive index material layer and a low refractive index metal layer;
the wire grid polarizer further comprises a mirror layer; and
a transparent film is laminated on the wire grid polarizer;
wherein, a backside reflection of the wire grid polarizer is below 6% and the mirror layer is configured to be protected by the transparent film.

2. The laminate of claim 1, wherein the transparent film is a colored transparent film.

3. The laminate of claim 2, wherein when the mirror layer is laminated with the colored transparent film, the optical lens provides a colored mirror appearance to a viewer.

4. The laminate of claim 1, wherein the transparent film is a functional film containing at least one photochromic compound.

5. The laminate of claim 4, wherein the functional film containing at least one photochromic compound is an adhesive.

6. The laminate of claim 5, wherein the adhesive is a polyurethane adhesive.

7. The laminate of claim 2, wherein the wire grid polarizer shows different intensities of transmitted and reflected colors when the transparent film is the colored transparent film.

8. The laminate of claim 7, wherein an intensity of a reflected color is higher than an intensity of a transmitted color.

9. The laminate of claim 1, wherein the wire grid polarizer comprises at least one high refractive index material layer having a refractive index of greater than 3.

10. The laminate of claim 9, wherein the at least one high refractive index material layer having the refractive index of greater than 3 comprises a germanium layer.

11. The laminate of claim 10, wherein the germanium layer has a thickness of about 20 nm.

12. The laminate of claim 1, wherein the laminate is protected by at least one additionally protective layer.

13. The laminate of claim 12, wherein the at least one additionally protective layer is a polycarbonate layer.

14. An optical lens, comprising:
a polymeric film having a structured surface;
a wire grid polarizer, having at least one high refractive index material layer and a low refractive index metal layer, and the wire grid polarizer is deposited on the structured surface of the polymeric film; and
a photochromic layer is deposited on the polymeric film to form a laminate;
wherein the laminate is enclosed between two protective layers.

15. The optical lens of claim 14, wherein a thickness of the photochromic layer is in a range of about 10-50 microns.

16. An optical lens, comprising:
a polymeric film having a structured surface;
a wire grid polarizer, having at least one high refractive index material layer and a low refractive index metal layer as a mirror layer, and the wire grid polarizer is deposited on the structured surface of the polymeric film; and
a colored transparent film laminated on the mirror layer of the wire grid polarizer;
wherein, the colored transparent film provides a colored mirror appearance of the optical lens to a viewer.

17. The optical lens of claim 16, wherein the wire grid polarizer provides a one-sided reflection control when the wire grid polarizer comprises one high refractive index material layer deposited on the low refractive index metal layer.

18. The optical lens of claim 16, wherein the wire grid polarizer provides a two-sided reflection control when the wire grid polarizer comprises two high refractive index material layers coated on both sides of the low refractive index metal layer.

19. The optical lens of claim 16, wherein a thickness of the colored transparent film is in a range of about 0.1 to 0.4 mm X-Y nm.

20. The optical lens of claim 16, wherein an intensity of a reflected color of the wire grid polarizer laminated with the colored transparent film is higher than an intensity of a transmitted color of the wire grid polarizer laminated with the colored transparent film.
